(19) United States
(12) Patent Application Publication
(10) Pub. No.: US 2012/0296701 A1
(43) Pub. Date: Nov. 22, 2012

(54) SYSTEM AND METHOD FOR GENERATING RECOMMENDATIONS

(75) Inventor: Hans C. Breiter, Lincoln, MA (US)

(73) Assignee: WAHRHEIT, LLC, Lincoln, MA (US)

(21) Appl. No.: 13/479,143

(22) Filed: May 23, 2012

Related U.S. Application Data
(63) Continuation-in-part of application No. 12/172,914, filed on Jul. 14, 2008, now Pat. No. 8,255,267.
(60) Provisional application No. 61/488,966, filed on May 23, 2011.

(51) Int. Cl. G06Q 30/02

(52) U.S. Cl. 705/7.33

(57) ABSTRACT

A system and method generates recommendations of products or services to individuals. Product rankings by a large number of individuals are translated into approach and avoid response data for various categories of the products or services. The translated data is utilized to compute approach entropy values, avoid entropy values, mean approach intensity values, and mean avoid intensity values. One or more of a trade-off plot, a value function plot, and a saturation plot may be generated from the values. The plots may be analyzed to derive preference feature values. Clusters may be formed of individuals with the same preference feature values. Products or services that are highly ranked by members of a cluster may be recommended to other members of the cluster that have yet to purchase or consume the highly ranked products or services.

### CROSS-REFERENCE TO RELATED APPLICATIONS

This application claims the benefit of U.S. Provisional Patent Application Ser. No. 61/488,966, filed May 23, 2011 for a SYSTEM AND METHOD UTILIZING PREFERENCE DYNAMICS, which application is hereby incorporated by reference in its entirety.

This application is a continuation-in-part of U.S. patent application Ser. No. 12/172,914, filed Jul. 14, 2008 for a SYSTEM AND METHOD FOR DETERMINING RELATIVE PREFERENCES FOR MARKETING, FINANCIAL, INTERNET, AND OTHER COMMERCIAL APPLICATIONS, which claims priority to U.S. Provisional Patent Application Ser. Nos. 60/959,406 filed Jul. 13, 2007, and 60/959,352 filed Jul. 13, 2007, which applications are hereby incorporated by reference in their entireties.

### BACKGROUND OF THE INVENTION

1. Field of the Invention

The present invention relates to systems and methods for generating recommendations to individuals.

2. Background Information

Retailers, both traditional and on-line, as well as media delivery services often provide recommendations to their members of additional products or services that those members may like. For example, on-line services, such as the Netflix service from Netflix, Inc. of Los Gatos, Calif., and the iTunes store from Apple, Inc. of Cupertino, Calif., generate recommendations and notify their members of these recommendations in an effort to increase sales and build customer loyalty. However, these recommendation systems typically have a low rate of success. That is, many of the recommendations turn out to be for products or services that the members are not interested in, or do not like as much as products and services that the members find on their own.

Accordingly, a need exists for a system that can provide recommendations having a higher success rate.

### SUMMARY OF THE INVENTION

In an embodiment, a system and method generates recommendations of products or services for clients or other individuals. The system may receive a large data set of rankings of products or services made by a large group of people, such as the members of one or more on-line product or service providers. The rankings, which may be in the form of a number or star ranking system, may be translated into approach and avoid response data. Approach response data provides a measure of the degree or level to which an individual approaches a particular product or service, i.e., likes that product or service. Avoid response data provides a measure of the degree or level to which an individual avoids a particular product or service, i.e., dislikes that product or service. The plurality of ranked products may be organized into categories based on one or more common criteria. For movies, the criteria may be genre, and exemplary categories may include Action/Adventure, Documentary, Comedy, Romance, Science Fiction, Mystery, etc.

Using the approach response data, approach entropy values may be computed for the individuals for the categories of products or services. Using the avoid response data, avoid entropy values may be computed for the individuals for the categories of products or services. For example, for each category, there may be both an approach entropy value and an avoid entropy value for each individual. In addition to the approach and avoid entropy values, mean approach intensity values and mean avoid intensity values as well as approach standard deviation values and avoid stand deviation values may be computed for the individuals for the categories.

One or more plots of the computed values may be generated. In an embodiment, a trade-off plot, a value function plot, and a saturation plot may be generated for each individual. The trade-off plot may plot the approach entropy versus the avoid entropy values computed for the individual for the categories. The value function plot may plot approach entropy versus mean approach intensity, and avoid entropy versus mean avoid intensity. The saturation plot may plot the approach standard deviation versus mean approach intensity, and avoid standard deviation versus mean avoid intensity. One or more preference feature values may be extracted from the generated plots. For example, preference feature values may include the relative ordering of the categories on the trade-off and/or value function plots. Other preference feature values may be constants of power functions or other curve fitting functions of the trade-off, value function, and/or saturation plots. Yet other preference feature values may be the slope of the value function plot at one or more locations, e.g., on either side of the origin. Still further preference feature values may be the maximum mean approach intensity value and the minimum mean avoid intensity value from the saturation plot.

The one or more preference feature values may be analyzed, and clusters of individuals who have the same preference feature values may be constructed. Once an individual is mapped to a cluster, a recommendation may be generated for that individual. Specifically, an item that the members of a cluster rank highly may be recommended to another member of that cluster who has yet to purchase or consume that item.

In another embodiment, individuals for whom product or service ranking data, purchasing history information, and/or demographic data is known may be tested using a predefined procedure. The procedure may present the individuals with a plurality of evaluation items that belong to predetermined categories. The procedure may collect approach and avoid response data from the individuals to the evaluation items that are presented to the individuals. The approach and avoid response data may be collected through the use of various techniques, such as keypresses on a keyboard, alternating keypresses, swiping a touchscreen, button holds on a touchscreen, etc. The collected approach and response data may be processed to produce one or more of the trade-off plot, the value function plot, and the saturation plot for the individual. In addition, preference feature values for these plots may be analyzed, and the individuals may be organized into clusters based on or more of the preference feature values.

The product or service ranking data, or the purchasing history data may then be overlaid onto the clusters. For example, statistically significant product/service ranking, purchase history, and/or demographic data may be mapped to respective clusters. An analysis of the product or service ranking data, the purchasing history information, and/or the demographic data as overlaid onto the clusters may be performed to generate recommendations for an individual member of a cluster. Additional analysis may be conducted to make determinations concerning market research, advertisement servicing, and networking suggestions to an individual member of a cluster.

### BRIEF DESCRIPTION OF THE DRAWINGS

The invention description below refers to the accompanying drawings, of which:

FIG. 1 is a schematic illustration of a system in accordance with an embodiment of the invention;

FIG. 2 is functional diagram of a relative preference server;

FIG. 3 is a flow diagram of method in accordance with an embodiment of the invention;

FIG. 4 is an illustration of a display screen used in the collection of response data;

FIG. 5 is an illustration of a timeline for the presentation of evaluation items;

FIG. 6 is a schematic illustration of a data record;

FIG. 7 is a flow diagram of a method in accordance with an embodiment of the invention;

FIGS. 8-21 are plots of relative preferences data;

FIG. 22 is a functional diagram of a prediction environment in accordance with an embodiment of the invention;

FIGS. 23A-B are a flow diagram of a method in accordance with an embodiment of the invention;

FIG. 24 is a flow diagram of a method in accordance with an embodiment of the invention;

FIGS. 25A-B are a flow diagram of a method in accordance with an embodiment of the invention; and

FIG. 26 is an illustration of a timeline for a presentation of evaluation items.

### DETAILED DESCRIPTION OF AN ILLUSTRATIVE EMBODIMENT

Overview

As described herein, relative preferences can be assessed by keypress or other procedures that quantify (i) decision-making regarding approach, avoidance, indifference, and uncertain/inconsistent responses, and (ii) judgments that determine the magnitude of approach and avoidance. Over the course of multiple experiments, the inventor evaluated whether splitting ratings of preference into explicit measures of approach and avoidance (while viewing beautiful and average faces, or distinct categories of facial expression, or distinct categories of physical activity, or food while the viewer is in different hedonic deficit states) reveals any regular patterns in behavior, such as a trade-off in approach and avoidance, or recurrent lawful patterns as observed with Kahneman and Tversky's prospect theory, or the Herrnstein-Baum matching law. Patterns for approach and avoidance were discovered by the inventor that are (i) recurrent across all stimulus types, and (ii) robust to noise. These patterns included: (a) a preference trade-off that counterbalances approach and avoidance responses, (b) a value function linking preference intensity to uncertainty about preference, and (c) a saturation function linking preference intensity to its standard deviation. All patterns demonstrated scaling between group and individual data. In addition, the keypress-based value function had the same general shape (i.e., curvilinear functions with the slope of the negative value function steeper than the slope of the positive value function) as the value function in prospect theory, and was consistent with the matching law for individual data. The inventor further evaluated the specificity of these patterns to gender biases and clinical abnormalities. These patterns verified known biases between females and males toward beautiful and average faces. When used to evaluate cocaine dependent subjects versus healthy controls, these patterns quantified the phenotype of the restricted behavioral repertoire associated with addiction. In general, these patterns provided a basis for mapping the space of relative preference in groups or individuals, leading to the current application of the uses of these recurrent, robust, and scalable patterns in relative preference for commercial applications.

In accordance with the present invention, raw measurement or evaluation data, such as keypress data, may be transformed in accordance with one or more defined mathematical procedures for presentation to the analyst who will make decisions based on the transformed data. As discussed in detail below, these procedures include, but are not limited to, a Shannon Entropy transformation, a Value Function transformation, and a Saturation transformation. The inventor has discovered that, over a wide range of subjects and tests, the responses of test subjects strongly tend to cluster along functional data paths defined by these transformations, reflecting an underlying pattern of human behavior and choices that is not readily observable when the data is presented in raw format (e.g., simple tabulations of key presses). This enables the analyst to more readily and confidently assess the responses and quickly differentiate the more desirable from the lesser. It also enables the analyst to quickly recognize responses that deviate substantially from the established patterns and thus are to be considered suspect.

Relative Preference System

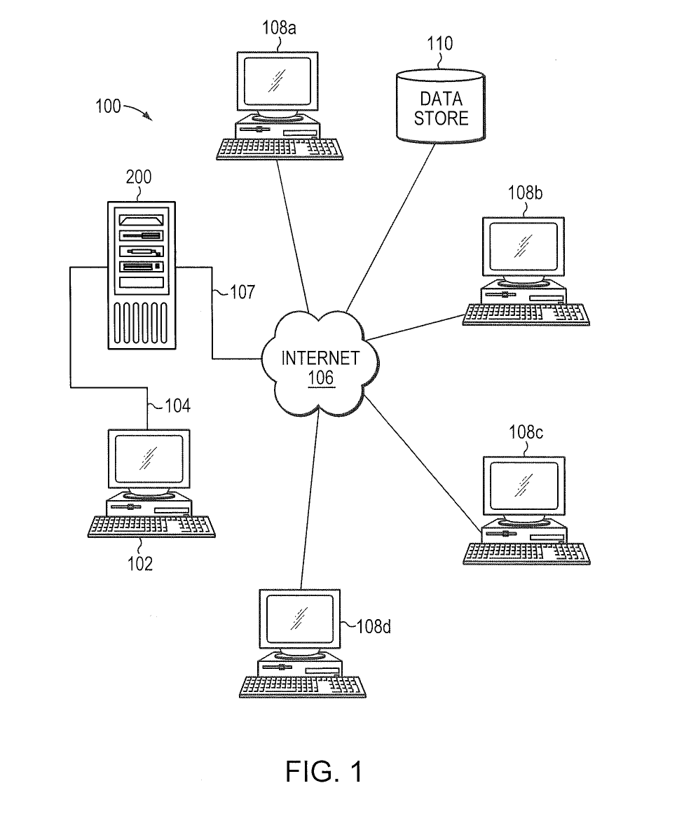

FIG. 1 is a schematic illustration of a relative preference system 100 in accordance with an embodiment of the invention. The system 100 includes a relative preference server 200 coupled to a management console 102 via a communication link 104. Server 200 is also coupled to a data communication network, such as the Internet, as illustrated by Internet cloud 106, via a communication link 107. Coupled to, or part of, the Internet 106 are a plurality of participant consoles, such as consoles 108a-d. Also coupled to the Internet 106 may be one or more data stores or data warehouses, such as data store 110. The data store 110 may contain product or service ranking data generated by a large number of individuals, e.g., thousands, millions or more individuals. Additionally or alternatively, the data store 110 may contain purchasing history and/or demographic data for a large number of individuals. Information may be stored in the data store 110 in terms of electronic records. Exemplary purchasing history may include the name and address of the purchaser, the actual product or service purchased, the date of purchase, the purchase price, the type of product or service, and the seller, among other information. Exemplary demographic data may include age, sex, marital status, educational level, income level, home ownership status, number of children, etc.

Server 200, management console 102, participant consoles 108a-d, and data store 110 may communicate by exchanging discrete packets or frames through the data communication network according to predefined communication protocols, such as the Transmission Control Protocol/Internet Protocol (TCP/IP) or the Internetwork Packet eXchange (IPX) protocol, among others.

In an embodiment, the management console 102 and the participant consoles 108 are each computers, such as workstations, desktops, notebooks, laptops, palm-tops, smart phones, personal digital assistants (PDAs), etc. Accordingly, the management console 102 and the participant consoles 108 each include one or more input devices, such as a keyboard, mouse, microphone, etc., one or more output devices, such as a display, speakers, etc., and communication facilities. Suitable computers for use as the management console 104 and the participant consoles 108 include the HP Pavilion series of computers from Hewlett Packard Co. of Palo Alto, Calif., the Inspiron series of computers from Dell Inc. of Round Rock, Tex., and the MacBook series of computers from Apple, Inc. of Cupertino, Calif. Those skilled in the art will recognize that other computer platforms may be advantageously utilized with the present invention.

It should be understood that in other embodiments, one or more or even all of the participant consoles 108 and the data store 110 may be directly connected to the relative preference server 200.

Relative Preference Server

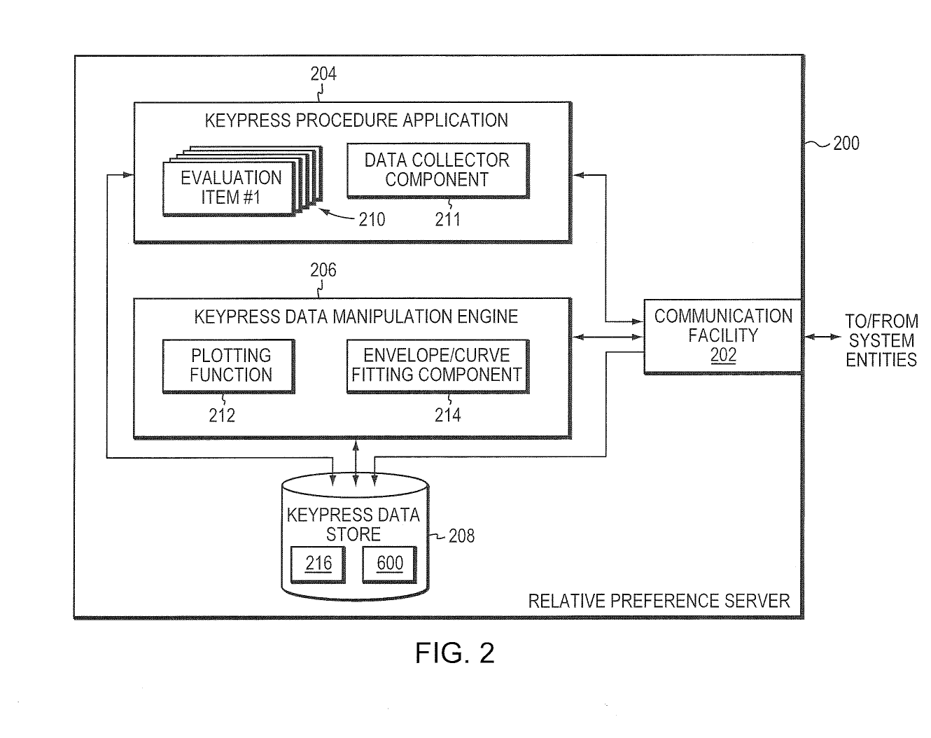

FIG. 2 is a schematic illustration of the relative preference server 200. Server 200 includes a communication facility 202, at least one keypress or other procedure application 204, a keypress data manipulation engine 206, and a keypress data store 208. The keypress procedure application 204, the keypress data manipulation engine 206, and the keypress data store 208 are each coupled to the communication facility 202. The keypress procedure application 204 may include a plurality of evaluation items, such as evaluation item no. 1, evaluation item no. 2, etc., designated generally 210. The keypress procedure application 204 may also include a data collector component 211. The keypress data manipulation engine 206 may include one or more plotting functions, such as plotting function 212, and one or more envelope/curve fitting components, such as envelope/curve fitting component 214. The keypress data store 208 may include a plurality of response data records, such as record 600, and a plurality of relative preference data records, such as record 216.

The communication facility 202 may include one or more software libraries for implementing a communication protocol stack allowing server 200 to exchange messages with other entities of the system 100 (FIG. 1), such as the management console 102, the participant consoles 108a-d, and the data store 110. The communication facility 202 may, for example, include software layers corresponding to the Transmission Control Protocol/Internet Protocol (TCP/IP), although other communication protocols, such as Asynchronous Transfer Mode (ATM) cells, the Internet Packet Exchange (IPX) protocol, the AppleTalk protocol, the DECNet protocol and/or NetBIOS Extended User Interface (NetBEUI), among others, could be utilized. Communication facility 202 further includes transmitting and receiving circuitry and components, including one or more network interface cards (NICs) that establish one or more ports, such as wired or wireless ports, for exchanging data packets and frames with other entities of the system 100.

Server 200 as well as the data store 110 may be a computer server having one or more processors, such as a central processing unit (CPU), and memories, such as a hard disk drive, interconnected by a system bus. Suitable servers for use with the invention include the HP ProLiant series of servers from Hewlett Packard Co., the PowerEdge series of servers from Dell Inc., and the IBM Blade Center series of servers from International Business Machines Corp. of Armonk, N.Y., among others.

It should be understood that one or more of the components of the relative preference server 200 may alternatively or additionally be included within the management console 102. For example, each of the components of the relative preference server 200 may be included in the management console 102, thereby eliminating the need for a separate server 200.

The keypress procedure application 204 and the keypress data manipulation engine 212 may include or comprise programmed or programmable processing elements containing program instructions, such as software programs, modules, or libraries, pertaining to the methods and functions described herein, and executable by the processing elements. Other computer readable media may also be used to store and execute the program instructions. The keypress procedure application 204 and the keypress data manipulation engine 212 may also be implemented in hardware through a plurality of registers and combinational logic configured to produce sequential logic circuits and cooperating state machines. Those skilled in the art will recognize that various combinations of hardware and software components, including firmware, also may be utilized to implement the invention.

The keypress data store 208 may be implemented on a hard disk drive, a redundant array of independent disks (RAID), a flash memory, or other memory.

Marketing Options

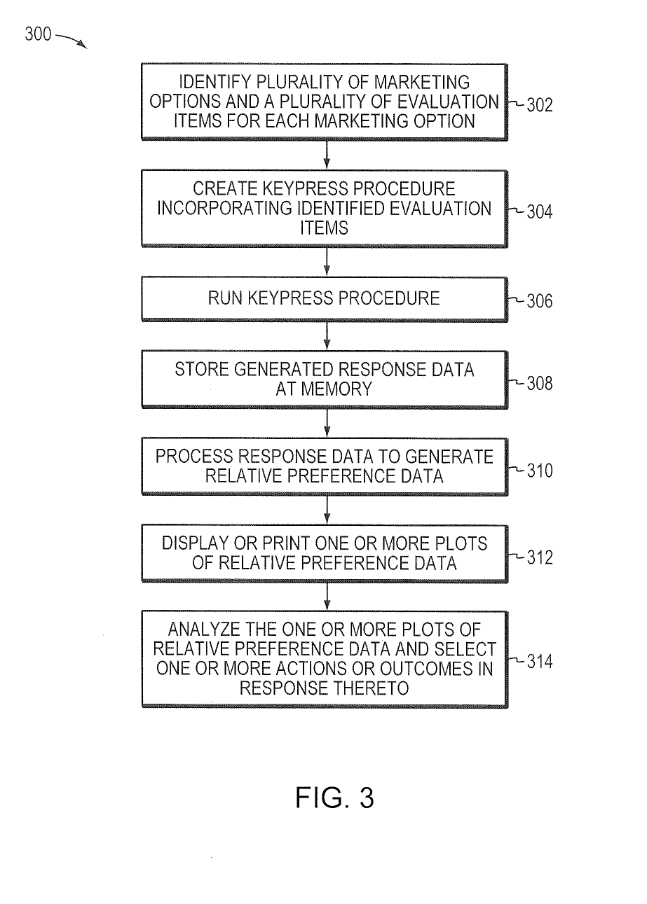

FIG. 3 is a flow diagram of a method 300 according to an embodiment of the invention. A developer identifies a set of marketing options (experimental conditions) to be tested or evaluated, and creates or defines a corresponding set of evaluation items (stimuli) for each of the marketing options, as indicated at block 302. Each evaluation item may illustrate a different view or use of the marketing option. In an embodiment, a set of marketing options may be proposed for existing products, packaging, or services, or advertising or marketing campaigns, etc. Those skilled in the art will recognize that other marketing options may be used, such as items in an inventory.

For example, suppose a consumer product company has developed five new proposed products or packaging, such as new razor blades, new packaging alternatives for shampoo, new soft drinks, new containers for a soft drink, etc., and is trying to choose which of the new proposed products or packaging designs to release to the marketplace. Each of these five proposed products or packaging designs represents a marketing option. For each marketing option, the developer creates or defines a set of evaluation items that can be sensed or perceived, e.g., visually, aurally, tactilely or through taste or smell, or some combination thereof, by participants. For example, for the proposed razor blades or the proposed soft drink containers, the set of evaluation items may be a series of photographs or video clips of each proposed razor blade or soft drink container. That is, for proposed razor blade no. 1, the developer may define or create 20 different photos of razor blade no. 1, such as the razor blade itself, someone using the razor blade, etc. For proposed razor blade no. 2, the developer may define or create 20 different photos of razor blade no. 2, and so on, so that for each marketing option there is a set of evaluation items. In an embodiment, each evaluation item illustrates only one marketing option.

It should be understood that the evaluation items may take other forms besides photographs or video clips. For example, if the marketing options for which relative preferences data is being sought are songs, then the evaluation items may be different excerpts from the songs that can be played through the speakers of the participant consoles 108. If the marketing options are perfumes or other scented products, the evaluation items may be samples of the perfumes or scents that the participant can smell.

Keypress Procedure

The developer next develops a keypress procedure incorporating the sets of evaluation items for the marketing options, as indicated at block 304. In an embodiment, a suitable keypress procedure is implemented through a computer program or application that displays the photographs or video clips to each participant, and allows the participant to either extend or shorten the time that a given photograph or video clip is displayed by entering keypresses on a keyboard at the participant console. The term “keypress procedure” is intended to broadly define any procedure in which preference based response data is generated by participants in response to being presented with evaluation items. As described herein, other response data besides keypress data may be generated by the participants and utilized by the system and method of the invention.

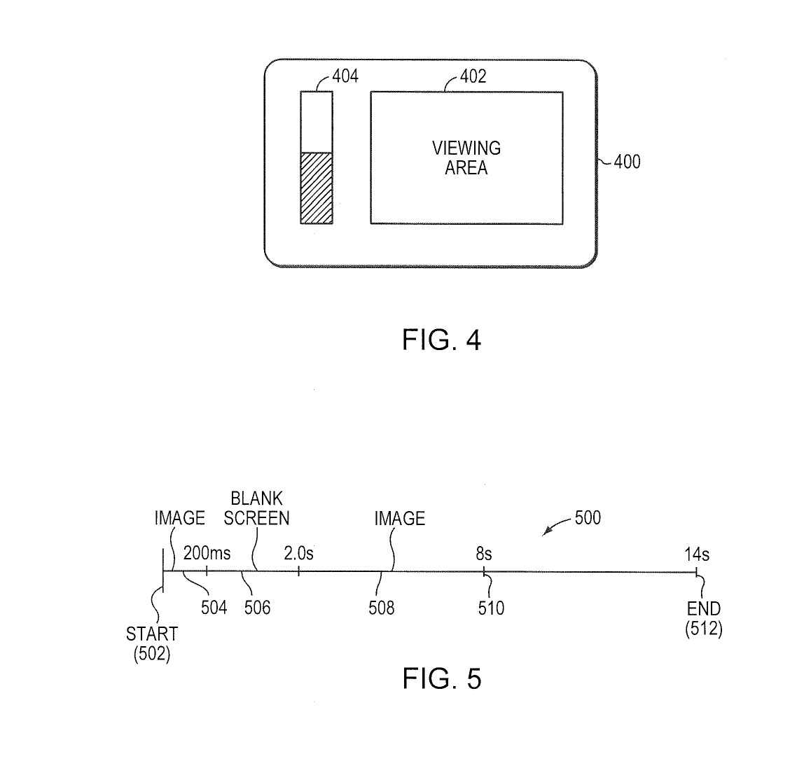

FIG. 4 is a schematic illustration of a screen 400 of a participant console 108 (FIG. 1) displaying the visible portions of a keypress procedure presented to a participant, and FIG. 5 is a timeline 500 of a keypress procedure. The screen 400 includes a viewing area 402 in which the current evaluation item, e.g., the current photograph or video clip, is presented or displayed. The screen 400 also may include a time remaining icon 404, which provides a visual indication to the participant of how much longer the currently presented evaluation item, e.g., photograph or video clip, will continue to be displayed. With reference to the timeline 500, the portion of the keypress procedure associated with each evaluation item, e.g., each given photograph or video clip, has a start time 502. In a first phase 504, the current evaluation item, e.g., the current photograph or video clip, may be displayed in viewing area 402 (FIG. 4) for approximately 200 milliseconds (ms). In a second phase 506, the current evaluation item, e.g., the current photograph or video clip, is removed from the viewing area 402 leaving the viewing area blank for approximately 1.8 seconds (s). In a third phase 508, the current evaluation item, e.g., the current photograph or video clip, is once again displayed in the viewing area 402. In an embodiment, the first two phases may not be used.

During the third phase 508, the participant can act to either lengthen or shorten the time that the current evaluation item, e.g., the current photograph or video clip, continues to be displayed in the viewing area 402. If the participant takes no action, the current evaluation item, e.g., the current photograph or video clip, is removed or stopped at a default time 510, which may be eight seconds, and the keypress procedure proceeds to the next evaluation item, e.g., the next photograph or video clip. If the participant finds the current evaluation item to be desirable or appealing, the participant may lengthen the time by which it remains displayed past the default time 510 by alternatingly pressing two keys on the keyboard of the participant console, referred to as the “approach” keys, such as the keys corresponding to the numbers 7 and 9, in a toggle-like fashion. By continuing to toggle between the two approach keys, the participant can cause the current evaluation item, e.g., the current photograph or video clip, to continue to be displayed up to a maximum time 512, e.g., fourteen seconds, thereby signaling both a preference toward the current evaluation item and the intensity of the participant's preference toward the current evaluation item.

If the participant dislikes the current evaluation item, the participant may shorten the time during which it is displayed by alternatingly pressing two other keys of the keyboard, referred to as the “avoidance” keys, such as the keys corresponding to the numbers 1 and 3, in a toggle-like fashion. By continuing to toggle between the two avoid keys, the participant can stop the display of the current evaluation item, e.g., the current photograph or video clip, sooner than the default time 510, thereby signaling both a dislike of the current evaluation item and the intensity of the participant's dislike toward the current evaluation item.

It should be understood that a participant may utilize both the approach keys and the avoid keys to variable degrees in an alternating fashion, while being presented with an evaluation item, e.g., while viewing a given photograph or video clip, thereby signaling both preference and dislike, e.g., uncertainty, regarding the current evaluation item.

Thus, the response data generated by a participant may indicate indifference or ambivalence toward the evaluation item (no action by the participant), a preference toward the evaluation item (toggling of just the approach keys), an avoidance of the evaluation item (toggling of just the avoid keys), or uncertainty/inconsistency in preference regarding the evaluation item (toggling both the approach and the avoid keys).

The time remaining icon 404 indicates how much longer the current evaluation item, e.g., the current photograph or video clip, will be displayed. The time remaining icon 404 may be a stack of thin horizontal lines that may be on, e.g., colored green, or off, similar to a graphic volume indicator. Those skilled in the art will understand that other graphical elements or widgets may be used. If the participant takes no action, the time remaining icon 404 begins dropping at the start of the third phase 508 and is completely empty at the default time 510, at which point the current evaluation item, e.g., the current photograph or video clip, is removed from the viewing area 402, and the keypress procedure application 204 proceeds with the next evaluation item, e.g., the next photograph or video clip. If the participant toggles the approach keys, then the time remaining icon 404 drops at a slower rate and may not reach an empty point until sometime after the default time 510 up to a maximum at the end time 512, depending on how many times and/or how quickly the participant presses the approach keys. If the participant toggles the avoid keys, then the time remaining icon 404 drops at a fast rate and may reach an empty point before the default time 510, depending on how many times and/or how quickly the participant presses the avoid keys.

In an embodiment, the keypress procedure presents each evaluation item, e.g., each photograph or video clip, to the participant according to the above-described process, as illustrated by the timeline 500. In another embodiment, there may be a maximum total test time for the entire keypress procedure. If a participant reaches this maximum total test time before viewing all of the evaluation items, the keypress procedure ends and the participant is not presented with or exposed to the remaining evaluation items.

In an embodiment, each marketing option or experimental condition has eight or more evaluation items, and may have on the order of twenty or more evaluation items. Nonetheless, those skilled in the art will understand that other numbers of marketing options and/or evaluation items may be used. For example, a keypress procedure having on the order of twenty marketing options or experimental conditions each having three evaluation items may be created.

The developer in addition to selecting the evaluation items also determines the sequence or order in which the evaluation items are presented to each participant. In an embodiment, the evaluation items of the various marketing options are interspersed following conservative experimental psychology procedures so that one experimental stimulus or response does not overweight the effects of others. This may be done by counterbalancing all categories of items, one item forward and one item backward in a sequence of such items. It may also be performed by pseudo-random intermixture of experimental stimuli with jitter of the inter-stimulus intervals so that the items, modeled by a hemodynamic waveform (as may be done for single-trial functional magnetic resonance imaging studies), produce minimal carryover effects by simulation.

Suitable keypress procedures are also described in I. Aharon et al. Beautiful Faces Have Variable Reward Value: fMRI and Behavioral Evidence, Neuron Vol. 32, pp. 537-551 (November 2001), and M. Strauss et al. fMRI of Sensitization to Angry Faces, Neuroimage, pp. 389-413 (April 2005), which are hereby incorporated by reference in their entireties.

It should be understood that the keypress procedure does not have be a toggle-like pressing of two keys by two fingers. For example, the procedure could involve a series of mouse clicks, a triple button press activated by three fingers in a row, a repetitive typewriter keystroke, etc.

It should further be understood, as indicated above, that other techniques or procedures may be used instead of a keypress procedure. Other such procedures may involve a lever press, a potentiometer, an on/off switch, or a touch screen element, among others.

With the lever-press procedure, the whole hand or a finger or foot or eye saccade or other motor output of the participant may be used to repetitively signal his or her preference toward approaching, avoiding, doing nothing about, or variably approaching/avoiding the evaluation item or stimulus. Such a procedure may be advantageous for participants whose fine-motor coordination is not well developed, or where physical constraints are imposed by the data collection process, the environment, or the personal medical condition of the participant.

The potentiometer procedure may be implemented using a button that the participant twists, e.g., to move a cursor on the screen in order to set the cursor at a level of the experience or effort that the participant is willing to expend. Alternatively, it may be implemented as the scrolling of a mouse, or as a lever or joystick that the participant pushes in any of N directions to signal N types of action. It may also be implemented with a device to scroll the participant's response as represented by an increasing or decreasing bar on the side of the screen.

The on/off switch procedure may advantageously be used with sound based evaluation items or stimuli, such as songs, or with any temporally extended type of stimuli, in which an evaluation item starts for a set amount of time, and the participant can terminate the exposure at any time, or repeat it. For example, the participant can start and stop the evaluation item, e.g., a song, a picture, a scent or odor, a physical sensation, etc., at any time with one type of signal, or that will stop on its own when it reaches a pre-determined exposure time or “default time”, unless the participant produces another type of signal so that the evaluation item continues on for another pre-determined window of time. With enough repetitions of the repeat signal, the evaluation item, e.g., song or film, may be heard or viewed by the participant.

The response data of the on/off switch procedure may be a view time or exposure time for each evaluation item. This response data may be partitioned as “avoidance” if it is below a mean view time for the group of participants, or as “approach” if it is above the mean view time. Alternately, the view time or exposure time response data may be used to produce a positive value function plot and saturation plot alone from analyses.

As described, a suitable procedure may permit a participant to control the amount of his or her exposure to a visual, auditory, somatosensory, gustatory, olfactory, vestibular, or other stimulus or evaluation item. Each procedure involves some way to transcribe physical effort (involving energy expenditure by the participant) into time of exposure.

In another embodiment, the procedure also may be used to signal how much money a participant would spend to approach, avoid, do nothing about, or variably approach/avoid an evaluation item or stimulus. Alternately, a “keypress” procedure may be used to signal a transaction using some measure other than money, such as points, or any item of commercial value that could be used for barter.

Those skilled in the art will understand that other procedures may be used or that modifications to the procedures described herein may be made.

Keypress Data Collection

A plurality of participants run the keypress procedure, as indicated at block 306 (FIG. 3). In an embodiment, the keypress procedure application 204 including the evaluation items is stored at and accessible from the relative preference server 200 (FIG. 1). A participant located at a respective participant console, e.g., console 108a, accesses the keypress procedure application 204 from the server 200, utilizing the data communication network, e.g., the Internet 106. For example, the participant may access the keypress procedure application 204 and run the keypress procedure through a World Wide Web (WWW) web site hosted by the server 200. The participant may be given a login identity (ID) that is unique to the particular participant, and a password to access the keypress procedure application 204 and run the keypress procedure, or they may not need login and password procedures.

It should be understood that the participant may be provided with instructions on how to run the keypress procedure.

It should be further understood that each participant may provide demographic information about himself or herself, such as age, sex, marital status, employment status, income, education level, buying habits, computer Internet Protocol (IP) address, race, languages spoken, etc.

In an embodiment, a participant may download a keypress procedure from server 200, run it on his or her console 108, and transmit response data, e.g., by e-mail, to server 200. In another embodiment, the participant may run the keypress procedure off of his/her smart phone, iPAD or similar wireless communication or computation device. Those skilled in the art will recognize that other ways of accessing and running a keypress procedure and collecting response data may be used.

Response data generated during each participant's running of the keypress procedure is captured and stored, as indicated at block 310. The data collector component 211 of the keypress procedure application 204 captures and stores the response data, which may include the total time that each evaluation item is maintained, e.g., viewed for photographs or video clips, by the participant, the number of approach keypresses and the number of avoid keypresses. The data collector 211 may organize the response data into records, and store the records at the keypress data store 208.

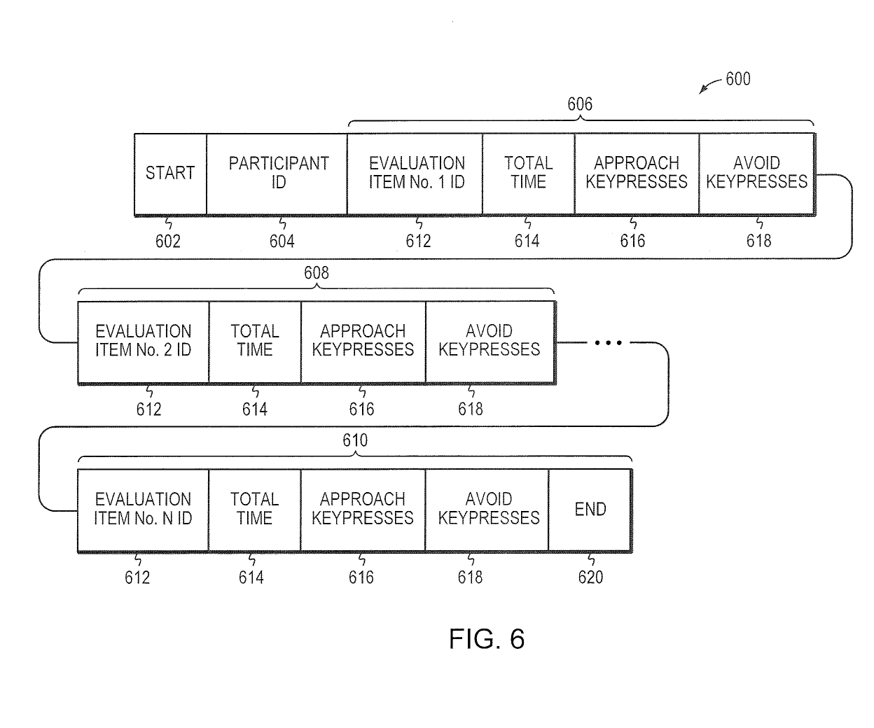

FIG. 6 is a schematic illustration of a response data record 600 for a given participant. The data record 600 is organized into a plurality of fields, including a start field 602, a participant ID field 604, and a evaluation item area for each evaluation item in the keypress procedure, such as evaluation item areas 606, 608 and 610, which correspond to evaluation items 1, 2 and N. The participant ID field may store the participant's name or login ID. Each evaluation item area, moreover, may include a item ID field 612 that identifies the particular evaluation item, a total time field 614 that holds the total time that the respective evaluation item was viewed by the participant, an approach keypresses field 616 that stores the number of approach keypresses entered by the participant for that evaluation item, and an avoid keypresses field 618 that stores the number of avoid keypresses entered by the participant for that evaluation item. The data record 600 may also include an end field 620. For each participant running the keypress procedure, a respective response data record 600 is created and stored at the keypress data store 208.

It should be understood that additional or other response data may be collected.

In an embodiment, the keypress procedure is defined so that, for each marketing option or experimental condition, there will be evaluation items that received approach keypresses and other evaluation items that received avoidance keypresses by each participant. For example, suppose the experimental conditions are faces that may be categorized as: beautiful female, average female, beautiful male, and average male. Suppose further that, for each experimental condition, there are twenty evaluation items, e.g., twenty pictures of beautiful female faces. In this case, a participant may enter approach keypresses for 18 of the 20 beautiful female faces, but avoidance keypresses for the other two. Furthermore, the keypress procedure may be defined in such a way that the participant while being presented with a current evaluation item associated with a given marketing option or experimental condition is unlikely to remember how he or she responded to prior evaluation items associated with this given marketing option or experimental condition.

Relative Preferences Data Processing

After each participant runs the keypress procedure, and the resulting response data is collected and stored at the keypress data store 208, the response data is processed to generate relative preference data for the marketing options represented by the evaluation items, as indicated at block 310. Specifically, the keypress data manipulation engine 206 accesses the response data records 600 stored at the keypress data store 208, and processes the information stored in those records 600 to generate relative preference data. As described herein, the relative preference data generated from the response data may include one or more entropy values, mean approach keypress, mean avoid keypresses, and standard deviation values for approach and avoidance keypresses, among others.

Shannon Entropy

In an embodiment, the keypress data manipulation engine 206 computes, for each participant, an approach Shannon entropy value (H₊) and an avoid Shannon entropy value (H₋) for each marketing option. The approach Shannon entropy value (H₊) may be computed as follows:

$${H}_{+} = {\sum }_{i = 1}^{N} {p}_{+ i} * log ( 1 / {p}_{+ i} )$$

where,

is the current evaluation item,

N is the total number of evaluation items for a given marketing option,

p₊ᵢ is the relative approach probability for the i^{th} evaluation item, and

the log function is to base 2.

The relative approach probability for the i^{th} evaluation item corresponding to a given marketing option may be computed as follows:

$${p}_{+ i} = \frac{{m}_{+ i}}{M}$$

where,

m₊ᵢ is the number of approach keypresses for i^{th} evaluation item, and

M is the total number of approach keypresses for all evaluation items corresponding to the same marketing option.

It should be understood that view time (or other response data) may be used instead of approach keypresses.

The avoidance Shannon entropy value (H₋) similarly may be computed as follows:

$${H}_{-} = {\sum }_{i = 1}^{N} {p}_{- i} * log ( 1 / {p}_{- i} )$$

where,

i is the current evaluation item,

N is the total number of evaluation items for a given marketing option,

p₋ᵢ is the relative avoid probability for the i^{th} evaluation item,

and the log function is to base 2.

The relative avoid probability for the i^{th} evaluation item corresponding to a given marketing option may be computed as follows:

$${p}_{- i} = \frac{{l}_{+ i}}{L}$$

where,

l₋ᵢ is the number of avoid keypresses for i^{th} evaluation item, and

L is the total number of avoid keypresses for all evaluation items corresponding to the same marketing option.

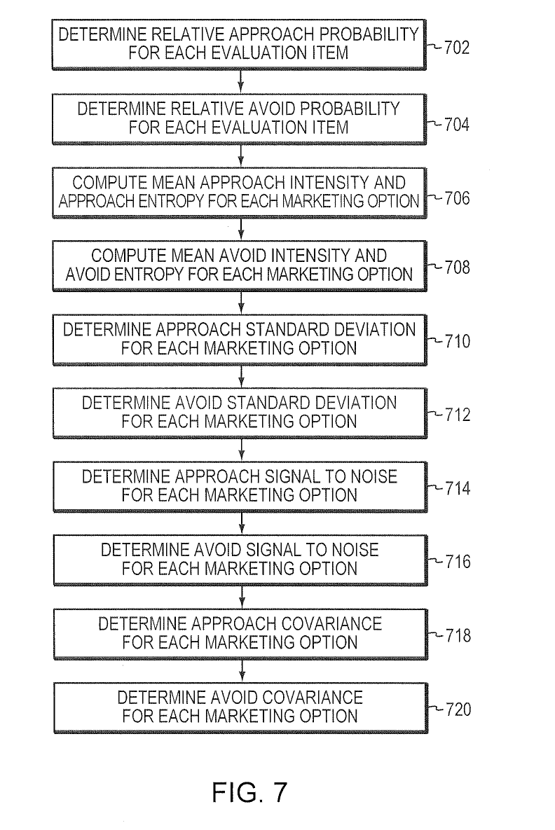

FIG. 7 is a flow diagram of a method of computing relative preference data. The keypress data manipulation engine 206 first may determine a relative approach probability for each evaluation item per participant, as indicated at block 702. The keypress data manipulation engine 206 may determine a relative avoid probability value for each evaluation item, as indicated at block 704. Continuing with the above example, suppose a participant entered a total of 400 approach keypresses while viewing the 20 photographs or video clips for proposed razor blade 1. Suppose further that the participant entered the following number of approach keypresses for the first three photographs or video clips of proposed razor blade 1:

photo/video clip #1: 9 approach keypresses

photo/video clip #2: 15 approach keypresses

photo/video clip #3: 12 approach keypresses

The keypress data manipulation engine 206 may compute the relative approach probability associated with these three photographs or videoclips as follows:

p1=9/400=0.0225

p2=15/400=0.0375

p3=12/400=0.03

Using the computed relative approach probability values, an approach Shannon entropy value (H₊) may be computed for each marketing option for each participant, as indicated at block 706. A mean approach intensity value for each marketing option also may be computed. Furthermore, using the computed relative avoid probability values, an avoid Shannon entropy value (H₋) may be computed for each marketing option for each participant, as indicated at block 708. A mean avoid intensity value for each marketing option also may be computed. The approach Shannon entropy value (H₊) and the avoidance Shannon entropy value (H₋) computed for a participant may be as follows:

razor blade 1: {3.1, 2.2}

razor blade 2: {0.5, 5.1}

razor blade 3: {4.2, 1.3}

razor blade 4: {1.9, 4.4}

It should be understood that other techniques or equations may be employed to compute the approach and avoid Shannon entropy values or other entropy values. For example, another way of computing suitable approach and avoid entropy values is given by:

$${H}_{+} = {\sum }_{i = 1}^{N} {p}_{+ i} / log {p}_{+ i}$$

$${H}_{-} = {\sum }_{i = 1}^{N} {p}_{- i} / log {p}_{- i}$$

It should be understood that the keypress data manipulation engine 206 may be configured to compute only an approach Shannon entropy value, or only an avoid Shannon entropy value for each marketing option.

It also should be understood that the keypress data manipulation engine 206 may be configured to compute other entropy values, such as entropy values based on second or third order models. A suitable equation for computing entropy of a second order model is given by:

$$H = {\sum }_{i = 1}^{m} {p}_{i} {\sum }_{j = 1}^{m} {P}_{ji} log {P}_{ji}$$

where Pᵢⱼ is the conditional probability that the present item is the j^{th} item in the set given that the previous item is the i^{th} item.

A suitable equation for computing entropy of a third order model is given by:

$$H = {\sum }_{i = 1}^{m} {p}_{i} {\sum }_{j = 1}^{m} Pji {\sum }_{j = 1}^{m} {P}_{kji} log {P}_{kji}$$

where Pₖⱼᵢ is the conditional probability that the present item is the k^{th} item in the set given that the previous item is the j^{th} item and the one before that is the i^{th} item.

Standard Deviation

In an embodiment, the keypress data manipulation engine 206 also may compute an approach standard deviation value for each marketing option per participant, as indicated at block 710, and an avoid standard deviation value for each marketing option per participant, as indicated at block 712.

The approach standard deviation value may be computed as follows.

$${σ}_{+} = \sqrt{\frac{1}{N} {\sum }_{i = 1}^{N} {( {K}_{i} - {K}_{M} )}^{2}}$$

where

σ₊ is the approach standard deviation,

N is the total number of evaluation items for the subject marketing option,

Kᵢ is the number of approach keypresses for the i^{th} evaluation item, and

K_{M} is the mean number of approach keypresses for all of the evaluation items for the subject marketing option.

That is, to compute the approach standard deviation, the keypress data manipulation engine 206 computes the mean approach keypresses for all of the evaluation items for a given marketing option, K_{M}. The keypress data manipulation engine 206 computes the deviation of the approach keypresses for each evaluation item from the mean, and calculates the square of these deviations (Kᵢ−K_{M})². The keypress data manipulation engine 206 then calculates the mean of the squared deviations, and take the square root of the mean of the squared deviations.

The avoid standard deviation, σ₋, may be calculated in a similar manner.

Signal to Noise (SNR)

In an embodiment, the keypress data manipulation engine 206 is further configured to compute an approach signal to noise (SNR+) value, as indicated at block 714, and an avoid signal to noise (SNR−) value, as indicated at block 716. A suitable equation for computing SNR+ is given by:

SNR₊=mean approach keypress intensity/σ₊

Similarly, a suitable equation for computing SNR− is given by:

SNR₋=mean avoid keypress intensity/σ₋

CoVariance

In an embodiment, the keypress data manipulation engine 206 is further configured to compute an approach covariance (CoV₊) value, as indicated at block 718, and an avoid covariance (CoV₋) value, as indicated at block 720. Suitable equations for computing CoV₊ and CoV₋ are given by:

CoV+=1/SNR₊

CoV−=1/SNR₋

Thus, for each marketing option, the keypress data manipulation engine 206 may generate the following relative preference data per participant, along with other location and dispersion measures of relevance to his or her preference behavior:

{H+, H−, mean approach keypress, mean avoid keypress, σ₊, σ₋, SNR₊, SNR₋, CoV₊, CoV₋}

It should also be understood that pre-existing data may be utilized as the response data. For example, suppose a consumer product company or other entity already has a series of consumer rankings of items, such as books or movies, on a scale from 1-5, with 5 indicating a consumer's preference toward the item and 1 indicating a consumer's dislike of the item. In this case, the rankings could be converted as shown below:

| Rank | Keypress Equivalent |
|---|---|
| 1 | 20 avoid keypresses |
| 2 | 10 avoid keypresses |
| 3 | no keypresses |
| 4 | 10 approach keypresses |
| 5 | 20 approach keypresses |

It should be understood that other conversions of preexisting product or service rankings to response data could be applied. In this way, stores of preexisting rankings of products or services could be used to calculate relative preference data for subsequent analysis, as described herein.

Relative Preference Data Plotting and Analysis

The relative preference data may be analyzed in order to make judgments and decisions regarding the marketing options that were evaluated or reviewed by the participants. Specifically, the relative preferences data may be plotted and the plots printed, displayed or otherwise presented to an evaluator, as indicated at block 312 (FIG. 3). Specifically, an evaluator may command the plotting function 212 of the keypress data manipulation engine 206 to generate one or more plots for display on the management console 102 and/or for printing. In an embodiment, the plots may include one or more of a Trade-off plot, a Value Function plot and a Saturation plot.

In addition, the plots and/or the relative preference data may be analyzed to derive an outcome or select an action, as indicated at block 314. These decisions may include, among other things, selecting one or more of the proposed products, services or product packaging for release to the marketplace, selecting one or more of the proposed advertising or marketing programs, targeting one or more proposed products or services to a particular target audience or sub-market. Those skilled in the art will understand that other decisions may be made based on the relative preferences data.

The keypress data manipulation engine 206 may be further configured to search the relative preference data for patterns and/or to organize the relative preference data in certain ways, and to present identified patterns to the evaluator to facilitate the selection of an outcome or action.

Preference Trade-Off Plot

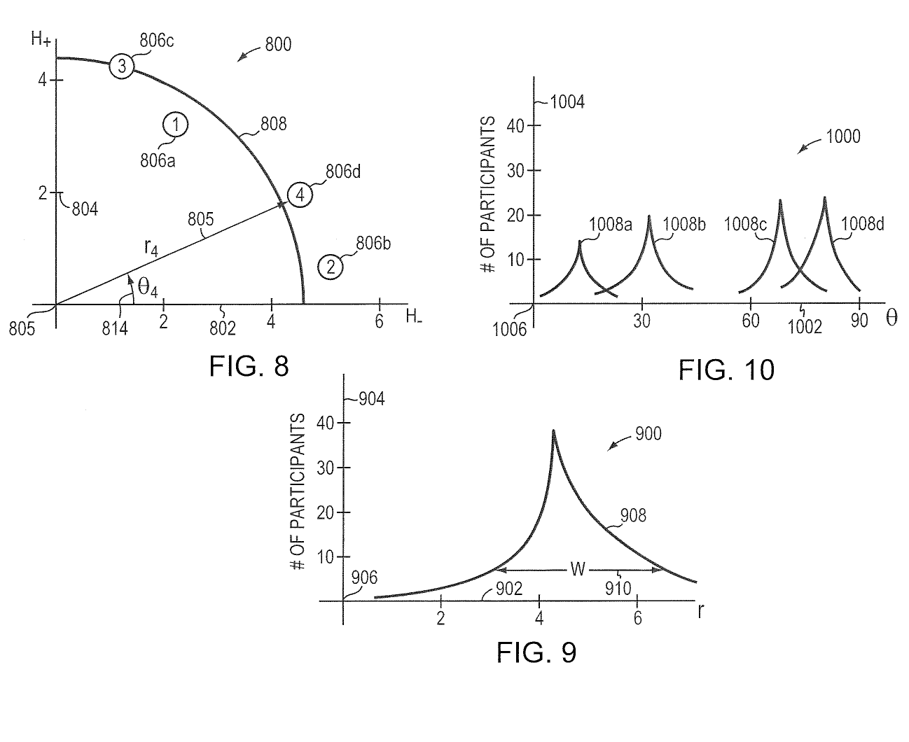

FIG. 8 is an illustration of a Trade-off plot 800 of relative preferences data computed for a single participant. The Trade-off plot 800 includes an x-axis 802 and a y-axis 804 that intersect at origin 805. The x-axis 802 represents H₋ values while the y-axis 804 represents H₊ values. As indicated above, for each marketing option, an {H+, H−} value pair may be computed. Accordingly, assuming the participant ran the keypress procedure for four marketing options, the {H+, H−} value pair 806a-d computed for each marketing option is plotted in the Trade-off Plot 800. Research by the inventor has demonstrated that the {H+, H−} value pairs of individuals and groups typically, but not always, fall generally along an arc 808 of constant radius, r, from the origin 805. This arc 808, moreover, provides an indication of the relative preference ordering of the four marketing options by the participant. Specifically, the marketing options that appear toward the upper left of the plot 800, i.e., marketing options 3 and 1, which have high H₊ values, were preferred by this participant while the marketing options that appear toward the lower right portion of the plot 800, i.e., marketing options 4 and 2, which have high H₋ values, were disliked by this participant.

The curve fitting component 214 may be directed to find a best-fit curve, such as arc 808, through the {H+, H−} value pairs 806.

In addition to plotting the {H+, H−} value pairs for a single participant, the evaluator may command the plotting function 212 to plot the {H+, H−} value pairs for all of the participants on a single Trade-off plot. By reviewing such a Trade-off plot, the evaluator may ascertain a preference for a particular marketing option by a majority of the participants, a dislike of a particular marketing option by a majority of the participants, etc. This interpretation may be quantified by determining the center of mass for the {H+, H−} value pairs for each marketing option or experimental condition, and comparing between these centers of mass for each marketing option or experimental condition. Alternately, the quantification of differences between marketing options or experimental conditions may be performed by evaluating radial and angular distribution plots, as described below, and showing a segregation of distributions between experimental conditions.

Alternately, it may be shown by application of bucket statistics, which are used in voxel-based neuroimaging analyses, such as statistical parametric mapping. This technique may be applied to the preference trade-off plots, and these graphs can be pixilated in the radial and polar dimensions. The incidence of real and hypothetical subject presence in each bucket or pixel can be compared to a Gaussian distribution, in a t-statistic analysis. The t-value can then be converted into a pseudocolor map on the preference trade-off plot, quantifying the segregation of experimental data between any two or more experimental conditions.

The keypress data manipulation engine 206 may be further configured to perform these tasks.

The evaluator may also direct the keypress data manipulation engine 206 to determine the number of participants that ranked the four marketing options in the same relative preference order. Suppose this determination produces the following relative preferences data:

| Relative Preference | No. of | % of Total |
|---|---|---|
| Order | Participants | Participants |
| 3, 1, 4, 2 | 96 | 48 |
| 1, 3, 2, 4 | 56 | 28 |
| 2, 1, 4, 3 | 22 | 11 |
| 3, 2, 4, 1 | 16 | 8 |
| 3, 4, 1, 2 | 10 | 5 |

A review of this relative preferences data by the evaluator reveals that 152 or 76% of the participants preferred marketing options 3 and 1 out of the four marketing options, and of these 152 participants most of them preferred marketing option 3 over marketing option 1. As a result, a decision may be made to release the proposed product or service that corresponds to marketing options 1 and 3 to the marketplace.

Radial and Angular Distribution Plots.

With reference to FIG. 8, each {H+, H−} value pair also has polar coordinates, e.g., {r, θ}, where r is the radial distance from the origin of the Trade-off Plot 800 to the respective {H+, H−} value pair, and θ is the angle of the radial, r, from the x-axis 802. Considering entropy pair 806d, for example, there is a radius, r₄, 812 and a polar angle, θ₄, 814. Thus, for every participant, in addition to a {H+, H−} value pair for each marketing option, there is also a polar coordinate pair for each marketing option.

In an embodiment, the keypress data manipulation engine 206 is configured to derive the polar coordinates, e.g., {r, θ}, for each marketing option for all of the participants. The plotting function 212 of the keypress data manipulation engine 206 is configured to produce a radial distribution plot and/or an angular distribution plot for display at the management console 102 and/or for printing.

FIG. 9 is an illustration of a radial distribution plot 900, which has an x-axis 902 and a y-axis 904 that intersect at an origin 906. The x-axis 902 represents the radial distance, r, of the {H+, H−} value pairs for all of the participants. The y-axis 904 indicates the number of participants, or other frequency information related to the participants. Based on research by the inventor, the radial distribution plot typically takes the form of curve 908. Curve 908, moreover, may have a full width half maximum measure (W) 910, or another dispersion measure which can be tested with the Levene statistic for differences in variance. The size of W 910 of curve 908 provides the evaluator with an indication of how restrictive the range of relative preference is, for a group of participants toward the marketing option represented by the curve 908. A narrowed spectra, as demonstrated by a low W measure, shows that these participants have less variance in their responses and thus greater certainty in their choice behavior. A wide spectra, as demonstrated by a high W measure, shows that these participants have a reduced certainty in their choices.

FIG. 10 is an illustration of an angular distribution plot 1000, which has an x-axis 1002 and a y-axis 1004 that intersect at an origin 1006. The x-axis represents the angle, θ, of the {H+, H−} value pairs for all of the participants. The y-axis 1004 indicates the number of participants. The angular distribution plot 1000 may show a separate curve, e.g., curves 1008a-d, for each of the marketing options. That is, curve 1008a may correspond to marketing option 2, curve 1008b may correspond to marketing option 4, curve 1008c may correspond to marketing option 1, and curve 1008d may correspond to marketing option 3. The closer a curve is to θ=90 degrees, e.g., curves 1008 and 1008d, the higher the approach entropy for the respective marketing option. Thus, the marketing options represented by curves near θ=90 were found by the participants to be desirable. Similarly, the closer a curve is to θ=0 degrees, the higher the avoid entropy for the respective marketing option. Thus, the marketing options represented by curves near θ=0 were disliked by the participants.

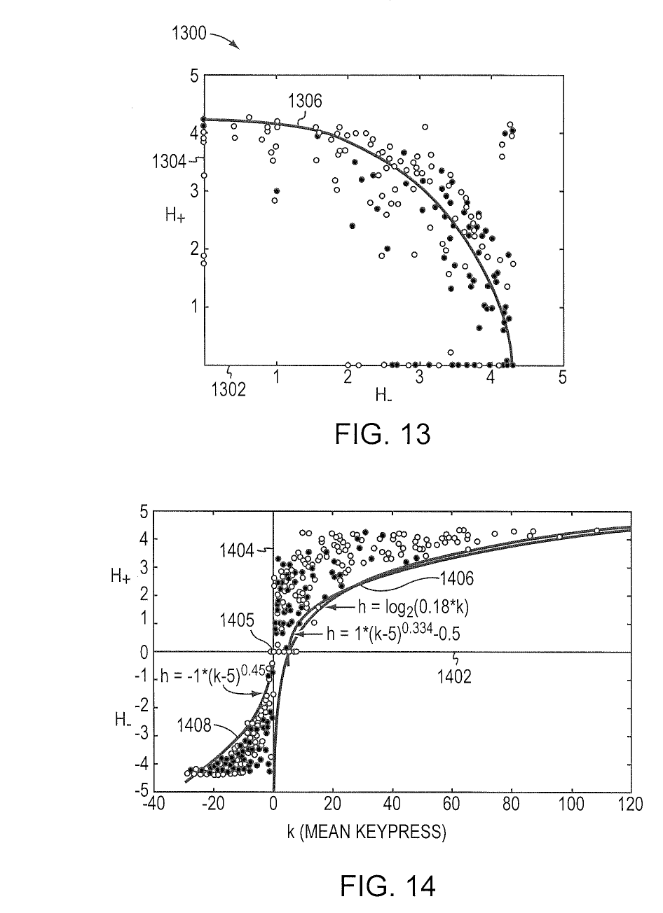

FIG. 13 is an exemplary Trade-off plot 1300 for a plurality of participants for four marketing options. As with plot 800, Trade-off plot 1300 has an x-axis 1302 that represents avoid entropy, H₋, and a y-axis 1304 that represents approach entropy H₊ that intersect at origin 1305. Depending on the noise characteristics of the experimental set-up, the relative preference data of Trade-off plot 1300, moreover, may have a central tendency that may be approximated by an arc 1306 of constant radius from the origin 1305.

The Trade-off plot, also referred to as a “preference trade-off”, represents a manifold across many subjects which can have a central tendency characterized by radius r=\sqrt{(H₊²+H₋²)}. The manifold generally has an internal border characterized by the simulation of a participant only making one of two decisions—to approach or to avoid. It has an outside border characterized by range-matched Gaussian noise simulated from hypothetical participants who make responses and are each matched to one real participant in the cohort for the range of responses. Many individual participants will produce responses across a set of experimental stimuli that fall clustered along the radius r=\sqrt{(H₊²+H₋²)} line; but this may not be necessarily so.

Furthermore, given an ensemble S with N items {x₁, x₂, x₃ . . . xₙ}=S, and

M subjects making transactions recording their preferences for those items, for each subject there may exist a random variable rₓ characterizing the radial distance from the origin for an {H_{x,+},H_{x,-}} graphing

[symbol]

rₓ=\sqrt{H_{x,+}²+H_{x,-}²}≈log₂ N

where “≈” means that:

$${\sum }_{1}^{M} \frac{{log}_{2} N}{\sqrt{{H}_{x , +}^{2} + {H}_{x , -}^{2}}} \to M ,$$

### as M→∞

and the probability that

$${r}_{1} \leq {r}_{x} \leq {r}_{2} \approx \frac{1}{σ \sqrt{2 π}} {\int }_{{t}_{1}}^{{t}_{2}} {e}^{- {t}^{2}} σ d t = P ( {t}_{1} , {t}_{2} )$$

$$when$$

$${t}_{1} = \frac{{r}_{1} - {log}_{2} N}{σ} , {t}_{2} = \frac{{r}_{2} - {log}_{2} N}{σ} , and$$

$${σ}^{2} = \sum ( {r}_{x} - {log}_{2} N ) P ( {r}_{x} ) , where$$

$$P ( {r}_{x} ) = \frac{{r}_{x}}{M}$$

This one-simplex manifold characterizes closed ensembles of N.

In an embodiment, the “preference trade-off” plot is evaluated or considered in light of the “value function” plot and the “saturation” plot, as described below.

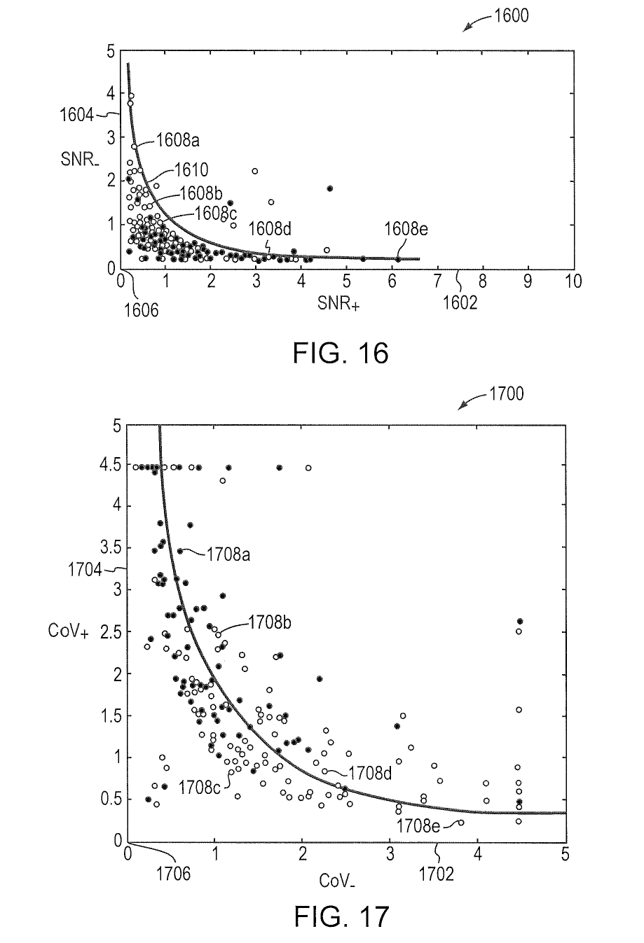

It should be understood that one or more preference Trade-off plots may be generated based on other relative preference data besides Shannon entropy. For example, the plotting function 212 may be configured to generate an SNR Trade-off plot. FIG. 16 is an illustration of an SNR Trade-Off plot 1600. The SNR Trade-off plot 1600 includes an x-axis 1602 and a y-axis 1604 that intersect at origin 1606. The x-axis 1602 represents SNR values while the y-axis 1604 represents SNR, values. As indicated above, for each marketing option, an {SNR₊, SNR₋} value pair may be computed. These {SNR₊, SNR_{-} value pairs, e.g., value pairs 1608}a-d, are plotted in the SNR Trade-off plot 1600. The envelope/curve fitting component 214 may be configured and/or directed to derive a boundary envelope 1610 for the relative preference data presented in the SNR Trade-off plot 1600.

The plotting function 212 may be further configured to generate a CoV Trade-off plot. FIG. 17 is an illustration of a CoV Trade-off plot 1700. The CoV Trade-off plot 1700 includes an x-axis 1702 and a y-axis 1704 that intersect at origin 1706. The x-axis 1702 represents CoV₋ values while the y-axis 1704 represents CoV₊ values. As indicated above, for each marketing option, a {Cov₊, CoV₋} value pair may be computed. These {Cov₊, CoV₋} value pairs, e.g., value pairs 1708a-e, are plotted in the CoV Trade-off plot 1700. The envelope/curve fitting component 214 may be configured and/or directed to fit a curve, e.g., curve 1710, to the relative preference data contained in the CoV Trade-off plot 1700.

Value Function Plot

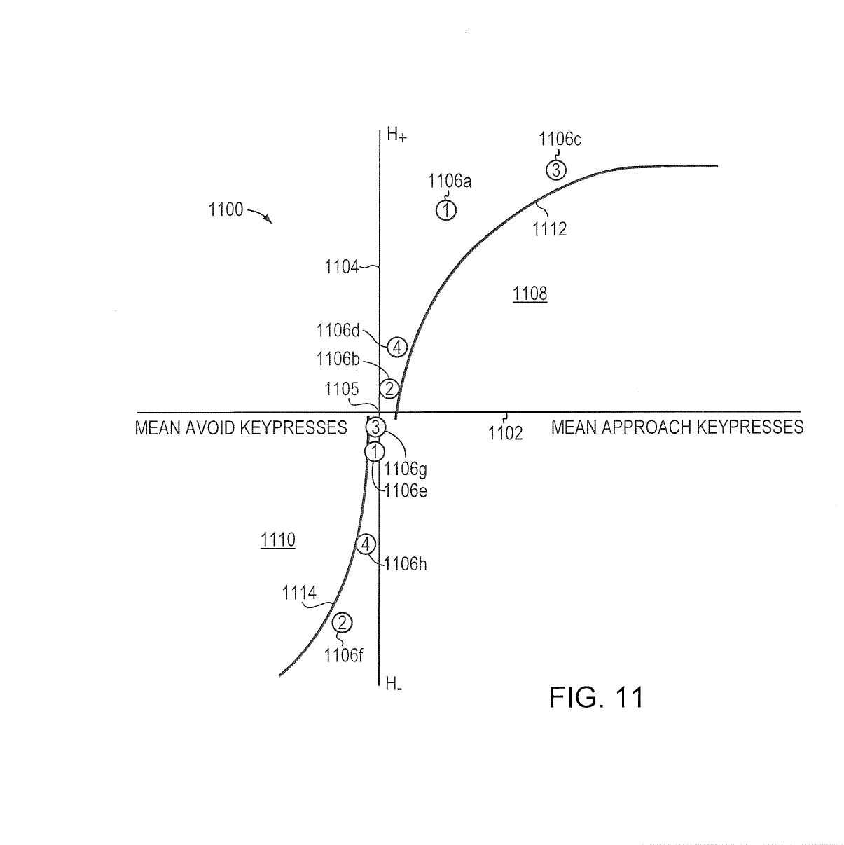

FIG. 11 is an illustration of a Value Function plot 1100 for the relative preference data generated for a single participant. The Value Function plot 1100 includes an x-axis 1102 and a y-axis 1104 that intersect at origin 1105. The x-axis 1102 represents mean keypresses with the positive side of the x-axis 1102 representing mean approach keypresses and the negative side of the x-axis 1102 representing mean avoid keypresses. The y-axis 1104 of the value function plot 1100 represents the Shannon entropy, with the positive side of the y-axis 1104 representing H₊ and the negative side of the y-axis 1104 representing H₋.

As indicated above, for each marketing option, there is a {H+, mean approach keypress} value pair and a {H−, mean avoid keypress} value pair. For each marketing option, these two value pairs are plotted on the Value Function Plot 1100, as indicated at 1106a-h. That is, for each marketing option, e.g., marketing option 1, there are two points that are plotted, one point, e.g., 1106a, in an H₊/mean approach keypress quadrant 1108 of the value function plot 1100, and the other point, e.g., 1106e, in a H₋/mean avoid keypress quadrant 1110.

The order in which the data points 1106a-h for the marketing options appear on the Value Function Plot 1100 provides an indication of the participant's relative ordering of the marketing options. Specifically, a participant's preference toward a marketing option increases in order of increasing H₊ values, and the participant's dislike of a marketing option increases in order of increasing H₋ values. The participant whose relative preference data appears in the value function plot 1100 ranked the four marketing options in the following relative order in terms of approach from high to low: 3, 1, 4, 2. The participant also ranked the four marketing options in the following order in terms of avoid from strongly avoid to weakly avoid: 2, 4, 1, 3. As shown, for this participant, the relative order of the marketing options in the avoid quadrant 1110 of the Value Function plot 1100 is symmetrical to the relative order of the marketing options in terms of approach. It should be understood that this may not always be the case.

Indeed, the relative ordering of preferences across the viewed materials, e.g., evaluation items and/or marketing options, may be different between the positive and negative keypress portions of the graph. This difference can be considered an indication of uncertainty/inconsistency connected to preference decisions and judgments. The differences in the relative orderings between the positive and negative components of the value function plot can be quantified by a Wilcoxin test of rank order. Strong inconsistencies in rank ordering of relative preferences for approach and avoidance responses may be associated with a trade-off plot where {H+, H−} value pairs are plotted far from the central tendency of the group manifold, and do not obviously convey rank ordering of relative preferences. Where consistency does exist in the value function graph between approach and avoidance responses for one or more experimental conditions, relative preference can be interpreted for that subset of experimental conditions in that participant or subgroup of participants. For all participants, it may be important to assess the difference in slopes between the approach and avoidance sections of the value function plot, to determine how “loss averse” a participant or a subgroup of participants is regarding the marketing options or experimental conditions tested. The extent of loss aversion may segregate subgroups of participants and suggest a marketing strategy toward one set of consumers that emphasizes how a product or a strategy promoting a product reduces some aspect of loss or bad outcome. The difference in slopes between approach and avoidance components of the value function plot is one part of how parameter fitting information for the graphs of participants can be useful. Other features of the parameter fits to the value functions of individuals include that related to the intercept of the x-axis, which reflects the core transaction costs that a participant sees around any consumatory, defensive, or procreative activity.

The curve fitting component 214 may evaluate the data 1106a-d plotted in the H₊/mean approach keypress quadrant 1108 of the value function plot 1100 to determine an approach boundary envelope 1112. Research by the inventor has shown that the approach boundary envelope 1112 may follow a power function given by:

f(x)=ax^{b}+c

where a, b, and c are variables, or it may be approximated by a logarithmic function given by:

f(x)=a*log_{B}[b(x+c)]+d

where a, b, c and d are variables, and B is the base of the logarithm.

The curve fitting component 214 may also evaluate the data 1106e-h plotted in the H₋/mean avoid keypress quadrant 1110 of the value function plot 1100 to determine an avoid boundary envelope 1114. Research by the inventor has shown that the avoid boundary envelope 1114 may follow a power function given by:

f(x)=ax^{b}+c

where a, b and c are variables, or it may be approximated by a logarithmic function given by:

f(x)=a*log_{B}[b(x+c)]+d

where a, b, c, and d are variables and B is the base of the logarithm.

It should be understood that a single Value Function Plot 1100 may be generated using the preference data for all of the participants that ran the keypress procedure. Similarly, separate Value Function Plots 1100 may be generated for those participants who had the same order of marketing options in terms of approach, avoidance or both.

FIG. 14 is an exemplary Value Function plot 1400 for a plurality of participants for four marketing options. As with plot 1100, the Value Function plot 1400 has an x-axis 1402 and a y-axis 1404 that intersect at origin 1405. The x-axis 1402 represents mean keypresses with the positive side of the x-axis 1402 representing mean approach keypresses and the negative side of the x-axis 1402 representing mean avoid keypresses. The y-axis 1404 represents the Shannon entropy, with the positive side of the y-axis 1404 representing H₊ and the negative side of the y-axis 1404 representing H₋.

The relative preference data within the approach entropy (H₊)/approach keypress portion of the Value Function plot 1400 follows an approach boundary envelope 1406. As shown in FIG. 14, the approach boundary envelope 1406 may fit or conform to a power function, e.g., H₊=1*(k−5)^{0.334}−0.5. Similarly, the relative preference data within the avoid entropy (H₋)/avoid keypress portion of the Value Function plot 1400 follows an avoid boundary envelope 1408. As shown in the figure, the avoid boundary envelope 1408 may fit or conform to a power function, e.g., H₋=−1*(−k)^{0.45}.

The approach and avoid boundary envelopes 1406, 1408 may also fit or conform to logarithmic functions.

The “value function plot” is either an envelope for group data, or a function for individual data. In both of these scenarios, it can be modeled as a logarithm, or as a power function. This means that the H₊/mean approach keypress plot and H₋/mean avoidance keypress plot are both considered as a logarithm, or as a power function. Given that alteration of the x-axis into logarithmic coordinates produces an envelope (group data) or function (individual data) that becomes linear, the envelope or function could be considered to be a power law. This argues more strongly for the power function formulation of both the H+/mean approach keypress plot and H−/mean avoidance keypress plot. Another argument for using the power function formulation of the value function graph, is that the “saturation function” is best fit as an envelope (group data) or function (individual data) when it incorporates a power formulation.

As a power function, this pattern may have the form: H_{±}≧a(K_{±}+c)^{b}+d, where H₊ is the entropy of increasing keypresses, H₋ is the entropy of decreasing keypresses, K₊ is the mean intensity of the increasing keypresses, and K₋ is the mean intensity of the decreasing keypresses, and a-d are fitting parameters.

If one assumes a logarithmic relationship, then one can have an alternate form for this function: H_{±}≧a+b log(K_{±}+c), with a-c as fitting parameters.

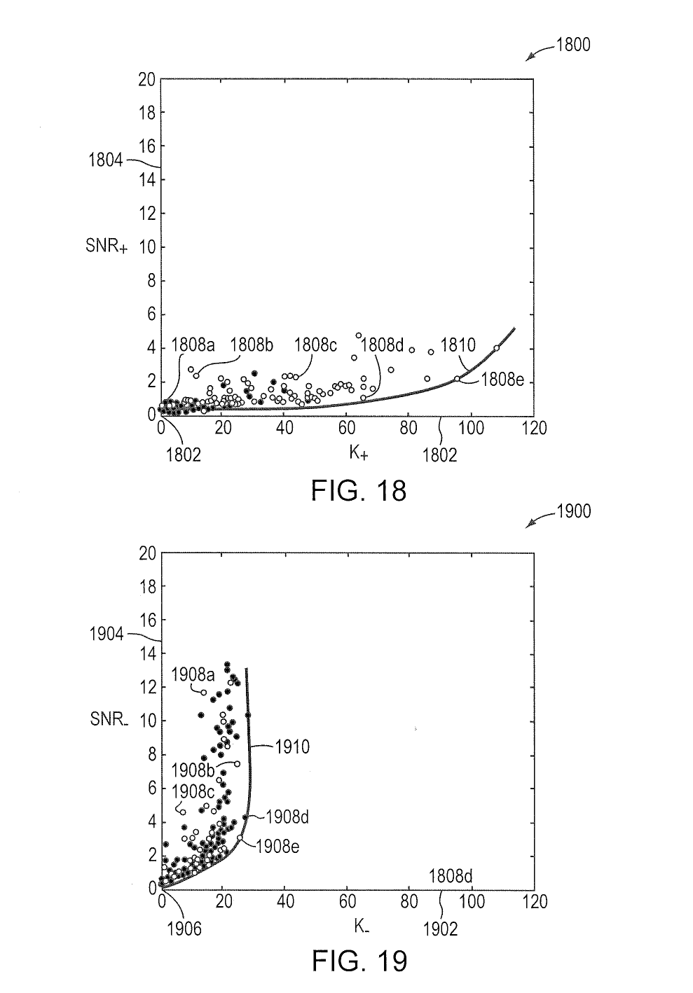

It should be understood that one or more Value Function plots may be generated based on other relative preference data besides Shannon entropy. For example, the plotting function 212 may be configured to generate one or more SNR Value Function plots. FIG. 18 is an illustration of an SNR+ Value Function plot 1800. The SNR+ Value Function plot 1800 has an x-axis 1802 and a y-axis 1804 that intersect at origin 1806. The x-axis 1802 represents mean approach keypress intensity (K+) values while the y-axis 1804 represents SNR+ values. As indicated above, the relative preference data includes a {SNR+, K+} value pair for each of the marketing options. These {SNR+, K+} is value pairs, e.g., value pairs 1808a-e, are plotted in the SNR+ Value Function plot 1800. The envelope/curve fitting component 214 may be configured and/or directed to determine an envelope 1810 for the relative preference data contained in the SNR+ Value Function plot 1800.

FIG. 19 is an illustration of an SNR− Value Function plot 1900. The SNR− Value Function plot 1900 has an x-axis 1902 and a y-axis 1904 that intersect at origin 1906. The x-axis 1902 represents mean avoid keypress intensity (K−) values while the y-axis 1904 represents SNR− values. As indicated above, the relative preference data includes a {SNR−, K−} value pair for each of the marketing options. These {SNR−, K−} value pairs, e.g., value pairs 1908a-e, are plotted in the SNR− Value Function plot 1900. The envelope/curve fitting component 214 may be configured and/or directed to determine an envelope 1910 for the relative preference data contained in the SNR− Value Function plot 1900.

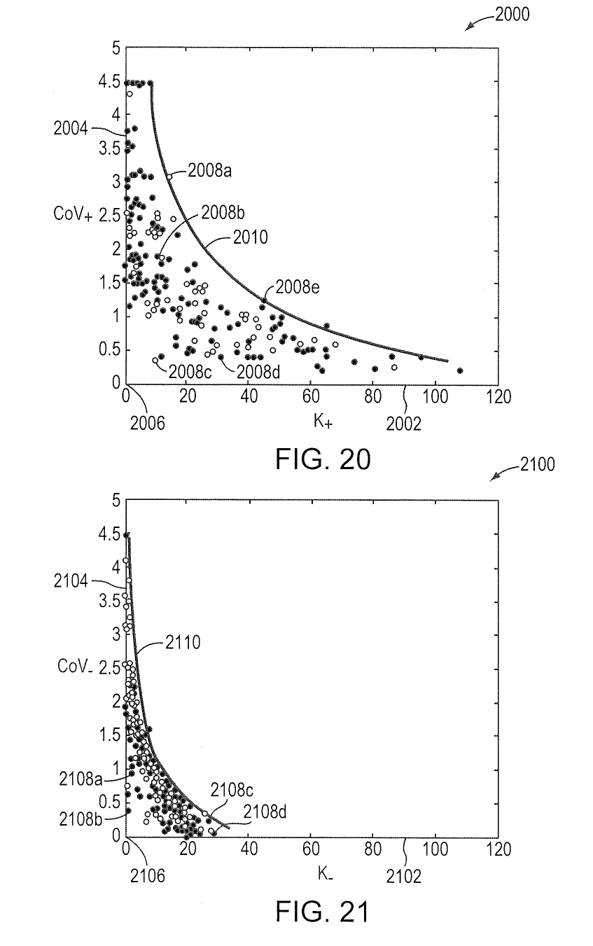

The plotting function 212 may be further configured to generate one or more CoV Value Function plots. FIG. 20 is an illustration of a CoV+ Value Function plot 2000. The CoV+ Value Function plot 2000 has an x-axis 2002 and a y-axis 2004 that intersect at origin 2006. The x-axis 2002 represents mean approach keypress intensity (K+) values while the y-axis 2004 represents CoV+ values. As indicated above, the relative preference data includes a {CoV+, K+} value pair for each of the marketing options. These {CoV+, K+} value pairs, e.g., value pairs 2008a-e, are plotted in the CoV+ Value Function plot 2000. The envelope/curve fitting component 214 may be configured and/or directed to determine an envelope 2010 for the relative preference data contained in the SNR− Value Function plot 2000.

FIG. 21 is an illustration of a CoV− Value Function plot 2100. The CoV− Value Function plot 2100 has an x-axis 2102 and a y-axis 2104 that intersect at origin 2106. The x-axis 2102 represents mean avoid keypress intensity (K−) values while the y-axis 2104 represents CoV− values. As indicated above, the relative preference data includes a {CoV−, K−} value pair for each of the marketing options. These {CoV−, K−} value pairs, e.g., value pairs 2008a-d, are plotted in the CoV− Value Function plot 2100. The envelope/curve fitting component 214 may be configured and/or directed to determine an envelope 2110 for the relative preference data contained in the SNR− Value Function plot 2100.

Saturation Plot

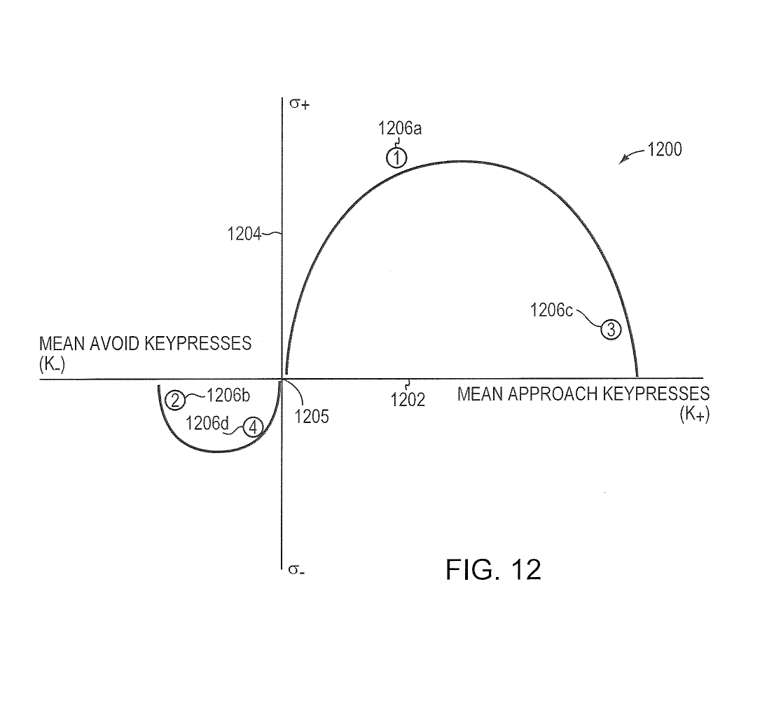

FIG. 12 is an illustration of a saturation plot 1200 for the relative preference data generated by a single participant. The Saturation plot 1200 has an x-axis 1202 and a y-axis 1204 that intersect at origin 1205. The x-axis 1202 represents mean keypresses with the positive side of the x-axis 1202 representing mean approach keypresses, and the negative side of the x-axis 1202 representing mean avoid keypresses. The y-axis 1204 represents the standard deviation, with the positive side of the y-axis 1204 representing standard deviation for approach, and the negative side of the y-axis 1204 representing standard deviation for avoid.

As indicated above, for each marketing option, there is a {σ₊, mean approach keypress} value pair and a {σ₋, mean avoid keypress} value pair. These two value pairs are plotted on the Saturation Plot 1200, as indicated at 1206a-d.

The distance a value pair 1206a-d is away from the x-axis, i.e., the magnitude of the standard deviation, indicates how difficult the decision was for the participant to either approach or avoid the respective marketing option. As indicated in the Saturation Plot 1200 although the participant entered approach keypresses for both marketing options 1 and 3, it was a significantly easier for the participant to decide to approach marketing option 3, than marketing option 1. In contrast, the degree of difficulty in deciding how to respond to marketing options 2 and 4, which both received avoid keypresses, was not that great.

It should be understood that a Saturation Plot 1200 may be generated using the preferences data for all of the participants that ran the keypress procedure. Similarly, separate Saturation Plots 1200 may be generated for those participants who had the same relative order of marketing options.

Based on a review of the saturation plot 1200 for a series of marketing options, a consumer product company may determine that, although a given marketing option received significant approach keypresses from the participants, the participants' decision to approach the given marketing option was difficult. Accordingly, the company may choose to proceed with a different marketing option that may have received substantially the same (or even slightly less) approach keypresses from the participants but, as reflected by the Saturation Plot 1200, the participants had less difficulty approaching this marketing option. Where participants had difficulty with judgment and decision-making regarding one or more marketing options or experimental conditions, as indicated by increased standard deviation estimates relative to other marketing options or experimental conditions, this data can then be evaluated with regard to relative loss aversion estimated from the approach and avoidance components of the value function, and to uncertainty/inconsistency with regard to differences in the relative ordering of approach and avoidance assessments for marketing options or experimental conditions. The increased standard deviation observed with one or more marketing options or experimental conditions may be due to ambivalent assessments (i.e., both high positive and high negative assessments for items in an experimental condition, or the same contradiction with low keypress assessments), or may be due to increased loss aversion, making a small set of avoidance keypress responses be amplified relative to the approach keypresses. It should be understood that there are other ways by which the interpretations extracted from the standard deviation data may be integrated with features extracted from the value function graph and the trade-off graph.

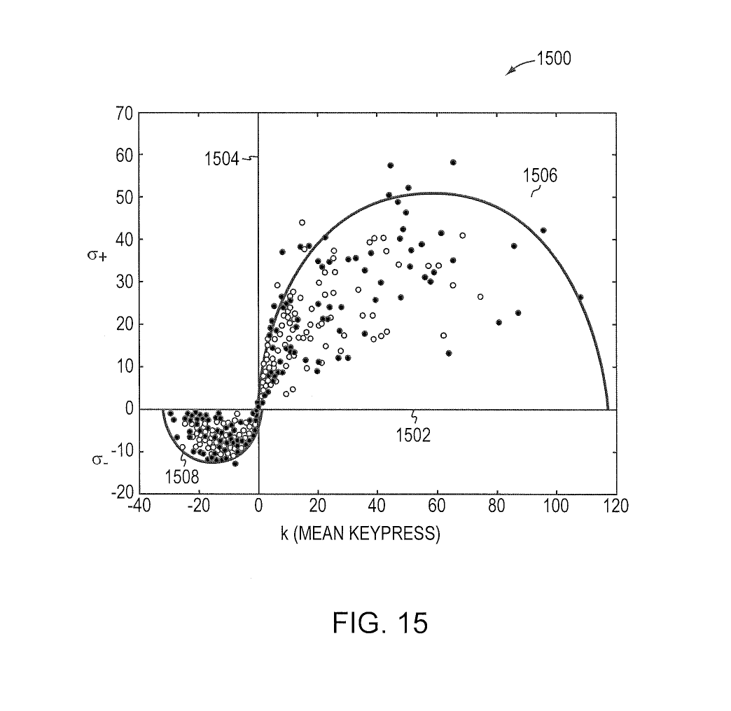

FIG. 15 is an exemplary Saturation plot 1500 for a plurality of participants for four marketing options. As with plot 1200, Saturation plot 1500 has an x-axis 1502 that represents mean keypresses, and a y-axis 1504 that represents standard deviation. The approach or positive standard deviation values follow an approach boundary envelope 1506 that is generally curved and leaves the baseline, achieves a maximum, and then approaches the baseline again, in the form of a saturation function. Similarly, the avoid or negative standard deviation values follow an avoid boundary envelope 1508 that is also curved but of smaller radius.

Graphs of group data for {K_{±},σ_{±}} produce distributions with well-delineated envelopes as illustrated in FIG. 15, which will be recurrent across many different types of marketing options or experimental conditions, and are likely to not be due to ceiling/floor effects in the behavioral response. In exemplar graphs, {σ_{±}} reaches a maximum/minimum before moving toward the K axis, so that the intensity versus variance goes up and returns toward baseline with repetitive behaviors, indicating a saturation relationship.

The envelope/curve fitting component 214 may be configured to determine the boundary envelopes 1506, 1508. The fitting parameters for the envelope are different for approach and avoidance (avoidance saturation is more compact than approach saturation), although the general description of the envelope is similar.

The boundary envelopes 1506, 1508 for the Saturation plot 1500 may be given by:

$${σ}_{+} = {aK}_{+}^{b} cos ( \frac{{K}_{+}}{c} )$$

$${σ}_{-} = {aK}_{-}^{b} cos ( \frac{{K}_{-}}{c} )$$

where, a, b and c are variables.

Alternatively, the {K_{±},σ_{±}} relationship may be modeled as: σ_{±}=a(K_{±}±b)²±c, where σ₊ is the standard deviation for increasing keypresses, σ₋ is the standard deviation for decreasing keypresses, K₊ is the mean intensity of the increasing keypresses, and K₋ is the mean intensity of the decreasing keypresses, and a −c are fitting parameters.

In an embodiment, the plotting function 212 and the kepress data manipulation engine 206 are configured to generate all three plots: Trade-off, Value Function, and Saturation from the generated relative preference data. An evaluation of all three plots provides significant information for deciding on a course of action with regard to the evaluated marketing options. Nonetheless, it should be understood that, in other embodiments, the plotting function 212 and the keypress manipulation engine 206 may be configured to generate only one of the Trade-off, Value Function, or Saturation plots. In still further embodiments, the plotting function 212 and the keypress manipulation engine 206 may be configured to generate some combination of the Trade-off, Value Function, or Saturation plots that is less than all three plots.

As described herein, relative preference data may be analyzed or evaluated to assess (i) the relative ordering of preferences across the viewed materials, e.g., evaluation items and/or marketing options, along the trade-off plot, value function plot, and saturation plot, i.e., the consistency of rank ordering across these three plots, (ii) the relative difference in steepness of slope between curves fitted to the avoidance and approach portions of the value function, (iii) the uncertainty associated with preference by the comparison of relative orderings between the avoidance and approach components of the value function plot, which may be quantified by a Wilcoxen test of rank ordering, and between each of these value function components and the preference trade-off graph, (iv) the parameter fits of the value function across persons in or between groups, (v) the dispersion and characteristics of the radial and polar sampling of the preference trade-off, (vi) the stimuli for which subjects found preference decisions to be relatively “hard” (where the standard deviation is highest) versus “easy” (where the standard deviation is least). If an answer regarding relative preference is not optimal, or unclear, moreover, these procedures can be repeated or redone with new evaluation items, experimental parameters and/or stimuli until an answer or optimal outcome is achieved.

Across the three types of graphs described, information that is extracted may be used to produce an integrated interpretation of relative preference for an individual, for a sub-group of individuals, and for a large group comprising distinctive sub-groups. The relative orderings of marketing options or experimental conditions along a trade-off plot, a value function plot, or a saturation plot may be listed in rank order, as indicated at point (i) above, and may include a scalar value of the K or H value associated with their graphing so that the set of marketing options or experimental conditions can be described as a vector for each participant or combined for each sub-group or group. Individuals may be clustered on the basis of rank orderings of preference or their preference vectors, and differences in preferences can be quantified between the sub-groups using standard nonparametric techniques for the location and dispersion across the group of the K value associated with the two marketing options or experimental conditions being compared across sub-groups. The consistency or uncertainty associated with preference may be compared between sub-groups of people by evaluating the difference in rank ordering of marketing options or experimental conditions between approach and avoidance components of the graph, as indicated at point (iii) above. This uncertainty/consistency may be quantified by a Wilcoxen test of rank ordering.

Differences in rank order of preferences and in the uncertainty/consistency of preferences may be important factors in assessing participant behavior. These differences also may be combined with an assessment of the ease with which participants make decisions, as indicated at point (vi) above. Rank order and consistency of rank order between approach and avoidance do not convey the relative difficulty of the judgment and decision-making involved with the preference, and thus may be supplemented by an assessment of which marketing options or experimental conditions were associated with the largest standard deviations. These types of information can be further supplemented by information regarding the relative steepness of the approach and the avoidance value functions for the participants. The slope of each component of the value function conveys how much a participant is willing to trade for a particular level of satisfaction or personal utility, as indicated at point (ii) above, related to approach/positive and avoidance/negative goal-objects. The less steep the slope, the more the participant is willing to trade for a particular level of satisfaction or personal utility. Some sets of participants may have strong similarities regarding their rank ordering of marketing conditions or experimental conditions, but may have significant differences in how much they are willing to pay for the same level of satisfaction. There also may be differences in terms of the transaction costs that participants are willing to incur, which is observed by the x-intercept of the value function, and can be extracted from the parameter fits for this function, as indicated at point (iv) above.

There also may be characteristics related to how uncertainty/consistency of rank order in the value function and the saturation function are conveyed with the preference trade-off plot. Trade-off plots may not show distinct orderings of market options or experimental conditions across a set of experimental conditions, and may not fall on the manifold observed across many subjects. In such cases, one may find significant inconsistencies between rank ordering of approach and avoidance responses in the value function and saturation function, indicating relative preferences that are likely to be strongly influenced by local factors, such as recent public discourse in the news regarding a marketing option or experimental condition or hedonic deficit state effects when the time scale of change associated with relative need for an experimental condition is short, e.g., food takes on increased positive/approach assessments with hunger and is devalued after satiation. Some features of a trade-off plot may not be readily apparent in the other plots, though. For instance, some participants may show a significant restriction in the range or dispersion of their preferences across the trade-off plot. Such a restriction in their trade-off plot may have diagnostic significance for psychiatric illness, such as addiction, or may have implications for how they are willing to NOT have a broadly distributed set of relative preferences. Such participants, like investors with restricted portfolios of assets or investments, may be strategic in their preferences for the short term. In general, such a profile may not be very adaptive to environmental change or changes in local influences over the long run.

It should be understood that the invention may be implemented in conjunction with neuroimaging. For example, neuroimaging may be performed with the advertising or marketing materials and a keypress or similar procedure may be implemented at relatively the same time or a later time. For example, if the keypress procedure is done outside of the neuroimaging, it may be used as a covariate in data analysis of the brain imaging data. Furthermore, the results of keypress procedure and the neuroimaging may be combined to increase the interpretive power of the process. Furthermore, if an optimal response is not obtained, then the process can be done iteratively.

It should be understood, as described above, moreover, that other procedures may be implemented in place of the keypress procedure. For example, the measure of preference in terms of keypress or time is not the only measure by which response data may be sampled. Response data, for instance, may be sampled by an individual keypressing for units of money or points that allow approach or avoidance. The units that demarcate relative preference do not have to be keypress or time, but could be any medium by which trades are made between potential goal-objects, e.g., gold, food-items, paper money, time, ratings, etc. As described above, it is also possible to transform existing frequency data so that it can be analyzed as described herein. For example, pre-existing movie rating data along a scale of 1-5 may be transformed an approach and avoidance scale as follows:

| Rank | Response Data |
|---|---|
| 1 | −2 |
| 2 | −1 |
| 3 | 0 |
| 4 | +1 |
| 5 | +2 |

In this way, existing frequency data may be mapped into response data. In an embodiment, the response data may include more than approach and avoid actions.

Furthermore, the evaluation items or stimuli that are used for mapping the preference space of an individual for marketing or advertising purposes need not be just stimuli related to the actual marketing or advertising materials, but could be stimuli of more general interest, such as photographs of sports, nature, activities, hobbies, and other general categories.

In addition, the present invention may be used to evaluate how relative preference data may be altered over time by relative deficit states or degrees of satiation, such as relative preferences for food before and after a hunger deficit state. In this case, the evaluation items or stimuli may include both normal colored food items and discolored food items to make them unappetizing. Other evaluation items or stimuli may include food items that are prepared and ready to eat and items that are unprepared or raw. The participants may be in one of two possible states during the keypress procedure: after an 18 hour fast, such as before the participant eats lunch, and after consuming a normal lunch. Such evaluations may point to how the temporal delivery of marketing communications can be salient—some messages will induce a greater preference response just before normal meal times than at other times. The present invention may provide a quantification of the differences in preference produced by these timing and stimulus alterations.

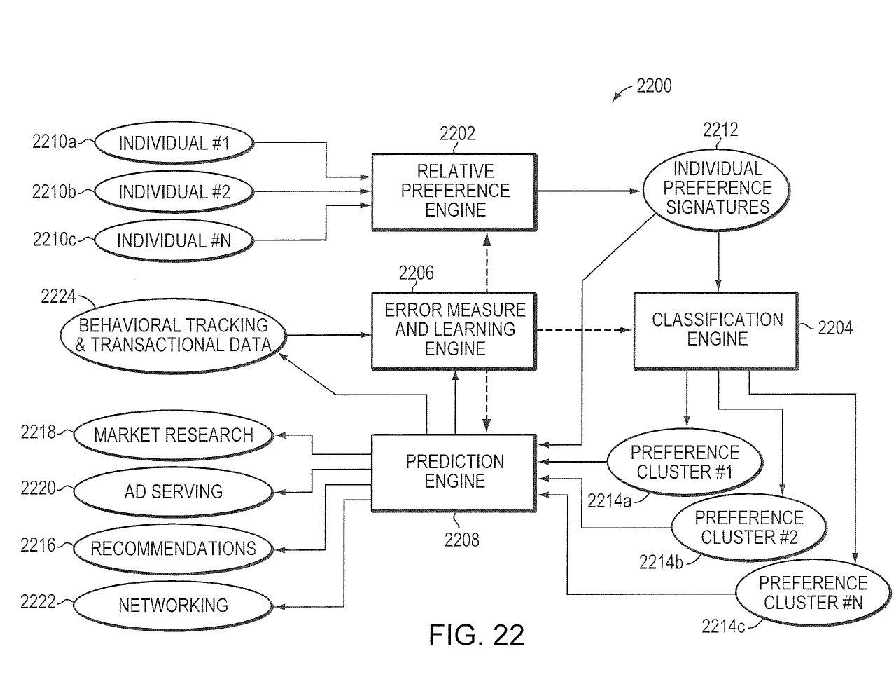

FIG. 22 is a schematic illustration of a prediction environment 2200 in accordance with an embodiment of the invention. The environment 2200 includes a plurality of components that interoperate as illustrated by the arrows. Specifically, the environment includes a relative preference engine 2202, a classification engine 2204, an error measure and learning engine 2206, and a prediction engine 2208. Approach and/or avoidance data, such as keypress or other data, for a plurality of individuals 2210a-c may be provided to the relative preference engine 2202. Using this data, the relative preference engine 2202 may generate individual preference signatures 2212 for the individuals 2210. The individual preference signatures 2212 may be processed by the classification engine 2204 to generate one or more preference clusters, such as clusters 2214a-c. The prediction engine 2208 may analyze these clusters 2214a-c, and generate recommendations 2216 for the individuals 2210 that satisfy the computed preference signature for that individual, or for individuals who were not used to identify the initial clusters 2214a-c, but whose individual preference signatures 2212 categorize them as belonging to an existing cluster 2214a-c. The prediction engine 2208 may also generate other outcomes, such as market research 2218, Advertisement (Ad) serving 2220, and networking 2222. For example, market research 221 may involve characterization of consumption, media usage, demographics, risk taking behavior, medical information that help marketers understand what items or services may be preferred by particular consumers characterized by age or gender; it may also relate to product packaging, product placement, range of features for a product to be offered, pricing or pricepoints. Ad serving may involve the placement of ads around a website or social networking space or within an application that the consumer may “click” on to get information about that product, service, coupon/groupon or other offering. Networking may connect the consumer to other like-minded individuals, or place them within social media to develop acquaintances, collaborations, life-partners, and the like. The prediction engine 2208 may make consumption suggestions based on the category of items with the highest H+ and lowest H− on the trade-off plot, or based on which categories have high K+H+ mapping plus low K−H− mapping (i.e., categories that are closer to the origin) on the value function plot, and have the lowest σ+ and highest K+ on the saturation plot. There are a large number of suitable metrics by which to use relative preference signatures of individuals to make recommendations. An example of Ad serving 2220 includes identifying coupons or other offers for goods or services, e.g., European travel, cruise ship travel, hunting equipment, fine wines, etc., that the individual is likely to enjoy or desire based on his or her computed preference signature. An example of a networking outcome 2222 includes the identification of other individuals who share similar interests or desires as a given individual.

Outcomes generated by the prediction engine 2208 may be analyzed by the error measure and learning engine 2206. The results of such analysis may be used to modify, e.g., refine, the operations of the relative preference engine 2202 and/or the classification engine 2204.

The prediction engine 2208 may also generate recommendations that techniques involving behavioral tracking or transaction monitoring (behavioral tracking & transactional data 2224) can evaluate for their predictive accuracy (i.e., how often a consumer acts on a recommendation and follows it). If a person acts on a recommendation by clicking on an ad, or accepting a coupon/groupon, or making a purchase, this information regarding follow-through to a recommendation may be measured and used to assess the efficacy of recommendations made to that individual. The error measure and learning engine 2206 may also analyze the behavioral tracking and transaction data 2224, and utilize the results of such analysis to modify the operations of the relative preference engine 2202, the classification engine 2204 and/or the prediction engine 2208.

The error measure and learning engine 2206 is not necessary for successful operation of relative preference-based recommendations, and it may or may not be integrated into the other components of 2200 for successful recommendations to be made. Similarly, it may not be necessary to use the classification engine 2204 for making recommendations; recommendations may be made directly from the individual or group preference signatures. If the error measurement and learning engine 2206 is applied, it may use basic machine learning principles so that the program may be said to learn from observation B related to a class of actions A and performance metric M, when its performance M at actions A improves due to observation B. After making predications that lead to some type of recommendation (actions A, which may relate to market research for developing a new product based on unmet consumer demand, or ads served to a cellphone user, or product purchase recommendations for a consumer on a website), the error measure and learning engine 2206 receives back performance data, regarding click-throughs on website advertisements or coupon offerings or transactions for products regarding the accuracy or some other metric of its recommendation performance. Based on the discrepancy between recommendations A and actual acceptance of recommendations M, the error measure and learning engine 2206 may use an unsupervised learning approach by evaluating observation B and the clustering it did and either reassigning the subjects with high error to a neighboring cluster or re-clustering the initial data and seeing what new clustering lead to better performance metric M.

As another embodiment, the error measurement and learning engine 2206 may use another machine learning approach such as reinforcement learning where actions A (e.g., recommendations) lead to negative feedback in the form of high error rates or positive feedback in the form of a reduction in error rates over a set of trials (e.g., performance metrics M), leading the error measure and learning engine 2206 to initiate a re-clustering effort by exclusion of one or more categories of products from analysis by the relative preference engine 2202, altering the downstream clustering outcomes 2214 and subsequent recommendations by the prediction engine 2208. There are a number of other routes by which someone versed in the art may use the error measure and learning engine 2206 to re-run analyses by the relative preference engine 2202 and classification engine 2204.

The relative preference engine 2202, classification engine 2204, prediction engine 2208, and error measure and learning engine 2206 may include or comprise programmed or programmable processing elements containing program instructions, such as software programs, modules, or libraries, pertaining to the methods and functions described herein, and executable by the processing elements. Other computer readable media, such as tangible media, may also be used to store and execute the program instructions. The relative preference engine 2202, classification engine 2204, prediction engine 2208, and error measure and learning engine 2206 may also be implemented in hardware through a plurality of registers and combinational logic configured to produce sequential logic circuits and cooperating state machines. Those skilled in the art will recognize that various combinations of hardware and software components, including firmware, also may be utilized to implement the invention.

The preference signatures 2212, preference clusters 2214, market research 2218, Ad serving 2220, recommendations, 2216, networking 2222, and behavioral tracking and transactional data 2224 may be stored as one or more data structures in one or more memories, such as main memory, a hard disk drive, a redundant array of independent disks (RAID), a flash memory, or other memory.

Applications to Large Data Sets

Entities, such as Netflix, Inc. of Los Gatos, Calif., Apple, Inc. of Cupertino, Calif., and Amazon.com, Inc. of Seattle, Wash., among others, have amassed and continue to amass large data sets of rankings of products, such as movies, videos, music, books, audio books, and other media, clothing, appliances, housewares, and other consumer products. This data may include or consist of rankings of individual products by individual purchasers or consumers, who may also be referred to as subjects. In an embodiment, some or all of this data may be analyzed to, for example, provide recommendations of other products to the subjects.

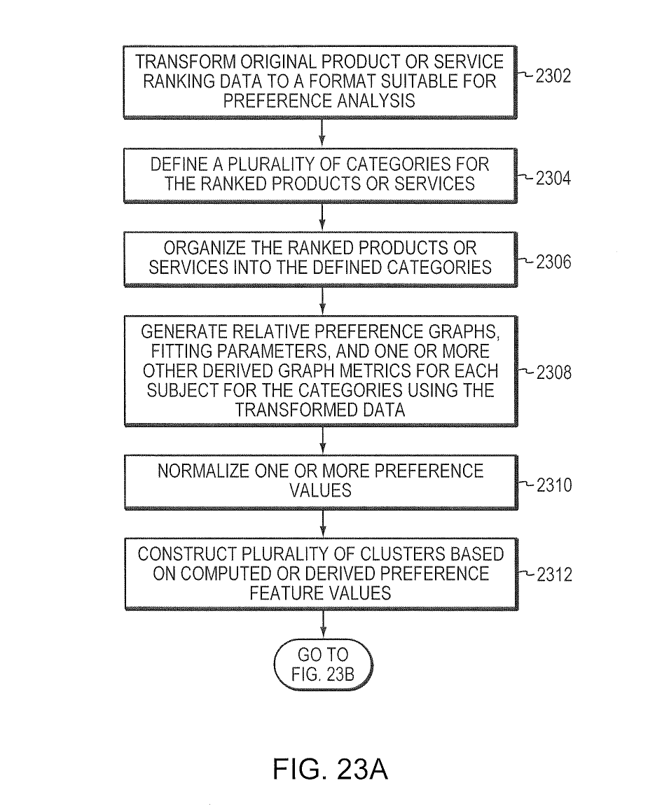

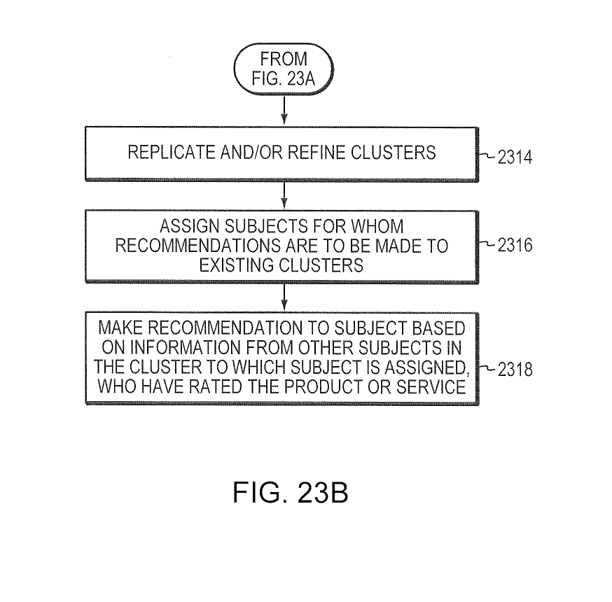

FIGS. 23A-b are a flow diagram of a method of analyzing at least a portion of a large data set.

The original format of the information of the large data set may be transformed to a second format that is suitable for processing by the present invention, as indicated at block 2302. For example, suppose the original information is a one to five stars or a number ranking system, where five is best and one is worst. In this case, the following transformation may be performed:

| Original Ranking | Transformed Value |
|---|---|
| 5 (great) | +2 |
| 4 (good) | +1 |
| 3 (neutral) | 0 |
| 2 (bad) | −1 |
| 1 (awful) | −2 |

It should be understood that other transformations may be utilized, such as the above-described transformation of original rankings to keypress equivalents.

A plurality of categories may be defined for the ranked items, as indicated at block 2304. Categories may be defined based on one or more attributes of the ranked products. For example, if the products are movies, books, or television shows, then one of the attributes of such items is genre or subject matter. In this case, a category may defined for each genre, such as Action/Adventure, Anime, Children's, Classic, Comedy, Documentary, Drama, Horror, Science Fiction, Romance, etc. It should be understood that other attributes may be defined, such as year of release, film director, producer, film studio, lead actress, lead actor, awards won by movie/screenplay writer/support staff and the like. Each item, e.g., each movie, book, and television show, may be assigned to one of the defined categories depending on whether the attribute of the item matches the attribute defined for the cluster, as indicated at block 2306. For example, movies, books, and television shows may be assigned to clusters based on the respective genre of the movie, book, or television show. In this way, there will be a group of product rankings, e.g., transformed values, for each subject representing the movies (or books or television shows) in each cluster. For example, transformed values 0, −1, −2, +1, −1, and 0 may belong to the items in the Horror cluster for a first subject.

To the extent the ranked products or services are such things as restaurants, vacation resorts, ski mountains, automobiles, wireless phone provides, etc. then other attributes may be used to organize the ranked products or services.

The relative preference engine 2202 may compute a set of preference values for a plurality of the subjects for the set of defined categories, as indicated at block 2308. The set of preference values computed by engine 2202 may be organized and stored as the preference signature 2212 for that subject. More specifically, utilizing the transformed values, which represent response data for the approach decisions and avoidance decisions for the items from one or more categories, a plurality of preference values may be computed, such as approach entropy values, avoidance entropy values, approach standard deviation, avoidance standard deviation, mean keypress (or its equivalent), approach covariance, avoidance covariance, etc. Here, the various categories, e.g., Action/Adventure, Comedy, Science Fiction, etc., are categories of items toward which the subject has made preference assessments.

In order to compute approach and avoidance entry values, a given subject needs to have ranked at least two movies in the respective category. Preferably, the subject will have ranked eight or more movies in each category, and potentially beyond 60 movies or items in each category. The inventor has run studies with 68 items per category, leading to precise value function, limit function, and saturation function fits (mean r²>0.9).

One or more of the relative preference values may be normalized, as indicated at block 2310, to account for the different number of items evaluated by a given subject in the various categories. For example, suppose that a subject ranked 22 action movies but only ranked 14 romance movies. A normalization factor may be applied to the computed preference values, such as the approach and/or avoidance entropy values, to account for the different numbers of ranked items in these categories. A suitable normalization factor is log₂N, where N is the number of ranked items in the category. Accordingly, the approach/avoid entropy values computed for the action movies category may be divided by log₂22, and the approach/avoid entropy values computed for the romance movies category may be divided by log₂14.

For a plurality of subjects, at least one of a preference trade-off plot, a value function plot, and a saturation plot may be generated, and included in the subject's preference signature 2212. In particular, the relative preference engine 2202 may compute data for generating one or more of these plots. In an embodiment, all of these plots may be generated for all of the subjects. The plots may be presented, e.g., displayed visually on a display screen and/or printed, to a reviewer. The computed plotting data may be stored in the preference signature 2212 for the individual.

The classification engine 2204 may analyze the computed preference signatures 2212 to construct the plurality of clusters 2214, as indicated at block 2312. A cluster refers to a set of preference feature values that are shared by, e.g., common to, a significant number of subjects. Exemplary preference feature values include the preference values themselves, e.g., H−, H+, σ−, a+, Kₘₐₓ, Kₘᵢₙ, etc.

In addition, the equation for the value function plot 1100 for a given subject may be given by:

H=a±b(K±c)^{d}

The equation for the saturation plot 1200 for a given subject may be given by:

σ=e(K±f)²+g

where a, b, c, d, e, f, and g are fitting parameters (e.g., constants), and may be derived from the respective plots using a curve fitting tool.

In addition, the points on the trade-off plot 800 for a given subject may be defined by polar coordinates (θ, r).

The set of preference feature values for a subject may also include these values, e.g., the constants a, b, c, d, e, f, and g, and θ, and r. In addition, as described in connection with the value function plot, evaluation items, in this case movie categories, appear in a particular ranked order. For example, for a given subject, the lowest ranked movie categories on the avoidance value function may be Honor, Science Fiction, and Documentary in that order. On the approach value function, the highest ranked movie categories may be Comedy, Action/Adventure, and Romance in that order. Preference feature values may also include such rankings from the subject's saturation function plot or trade-off plot.

Furthermore, considering the value function plot 1100, the slope, S⁺, of the approach curve near the origin 1105, e.g., near points 1106b and 1106d, may be computed. Similarly, the slope, S⁻, of the avoidance curve 1114 near the origin 1105, e.g., near points 1106g and 1106e, may be computed. These slope values, may be included as preference feature values, as can their absolute ratio, as given by:

$$\vert \frac{{S}^{-}}{{S}^{+}} \vert$$

In addition, Kₘₐₓ from the positive side of the saturation plot 1200, e.g., near point 1206c, and Kₘᵢₙ from the negative side of the saturation plot 1200, e.g., near point 1206b, may be included as preference feature values.

Preference feature values also may include ê where e is the mean displacement of all points around the central tendency of the H+H− trade-off plot 800, or the full-width half-maximum (FWHM) metric of the spectra from a radial sweep of multiple categories for one subject in the trade-off plot, or even across multiple subjects in a subgroup. The H+H− trade-off plot 800 can be characterized by collecting the radial distance of each H+H− data point in a histograph along the horizontal axis, and fitting that histogram to form a spectrum. The peak of the spectrum may be one metric by which to identify the central tendency of the group of data points in the H+H− trade-off plot. With such a central tendency, each subject may then be characterized by the distance of their data points ê from this central tendency (which resembles a semi-circle, but may be hyperbolic or fit another function). Another way to characterize this plot is to map the semi-circle which is r=log₂N, where N is the number of items in the categories plotted on the H+H− graph, and then summarize the mean/median/mode of distances (e.g., e) from this semi-circle for the data points from individuals or groups of individuals. The histogram/spectrum may be collected for a large number of H+H− data points from one subject, or from one category of data point across many subjects or a subgroup of subjects. It may also be used as a metric for identifying subgroups of subjects (e.g., those with low ê or high ê).

In an embodiment, a given cluster may include those subjects who ranked Honor, Science Fiction, and Documentary on the avoidance value function in that order. A second cluster may include those subjects who ranked Honor, Action/Adventure and Anime on the approach value function in that order. It should be understood that other clusters may be constructed based on the preference feature values. Any clustering method (e.g., k-means clustering) may be considered for assessing similarity and dissimilarity of preference feature values (e.g., the constants a, b, c, d, e, f, and g for value and saturation function fits of H=a±b(K±c)^{d} and σ=e(K±f)²+g). Different clustering methods make distinct assumptions about data structure, commonly referenced as a similarity metric and assessed by indices such as their internal compactness (similarity between item preference features in the same cluster) and separation of the identified clusters. Metrics such as graph connectivity and estimated density have also been developed for clustering, and provide quantitative outcomes by which to iteratively repeat clustering until an optimized set of metrics is achieved (e.g., the Netflix data with 400,000+ individuals may be clustered into 44 clusters with membership ranging from 400 subjects to 50,000 subjects, with better similarity metrics and internal compactness estimates than clustering results that produce 45-80 clusters or 5-43 clusters). Those skilled in the art will recognize that many types of clustering methods may be utilized depending on the data itself, to partition the larger group into meaningful subgroups.

Preference features from the relative preference functions that may be important for this clustering of individuals include, but are not limited to, the following:

(i) the fitting parameters (constants) a, b, c, d, e, f, and g for the value and saturation functions of H=a±b(K±c)^{d} and σ=e(K±f)²+g); these fitting parameters will be distinct for the positive value function H⁺=a±b(K⁺±c)^{d} and the negative value function H⁻=a±b(K⁻±c)^{d}; these fitting parameters will also be distinct for the positive saturation function σ⁺=e(K⁺±f)²+g and the negative saturation function σ⁻=e(K⁻±f)²+g; in total there may be fourteen or more fitting parameters (constants) that can be used as preference features of individuals; it is also important to note that the logarithmic variants of the positive and negative value functions may have distinct fitting parameters;

(ii) the Kₘₐₓ and σₘₐₓ of the positive saturation function, and the Kₘᵢₙ and σₘᵢₙ of the negative saturation function;

(iii) the slope of the positive value function s+ close to the origin, the slope of the negative value function s− close to the origin, and the absolute value of their ratio |s−/s+| which is considered a measure of loss aversion; s+ is computed by

$${\int }_{{x}_{1}}^{{x}_{2}} \frac{f ( x )}{d x} d x / ( {x}_{2} - {x}_{1} )$$

and s− is computed by

$${\int }_{- {x}_{1}}^{- {x}_{2}} \frac{f ( x )}{d x} d x / ( {x}_{2} - {x}_{1} ) ;$$

(iv) a measure of “risk aversion” from the value function computed as the second derivative of the value function, divided by the first derivative, midway along its graphical extent (i.e., not close to the origin);

(v) ê where e is the mean displacement of all points around the central tendency of the H+H− trade-off plot 800, for one subject in the trade-off plot, or even across multiple subjects in a subgroup; the central tendency for calculation of ê can be the peak of the spectrum from a radial sweep of the H+H− trade-off plot, or may be the semi-circle which is r=log₂N, where N is the number of items in the categories plotted on the H+H− graph; ê can also stand for any location estimate such mean, median, or mode, or it could stand for a dispersion estimate such as the standard deviation or standard error;

(vi) the full-width half-maximum (FWHM) metric of the spectra from a radial sweep of multiple categories for one subject in the trade-off plot, or even across multiple subjects in a subgroup;

(vii) the mean/median/mode radial distance from the origin for data points of categories in the H+H− trade-off plot;

(viii) polar coordinates (θ, r) can also be substituted for use of {H+, H−} coordinate values in the trade-off plot;

(ix) the rank ordering of the categories graphed on the K+H+ value function, with their relative placement to other categories along the positive value function being determined by the shortest distance to the value function fit (i.e., to H⁺=a±b(K⁺±c)^{d} or the logarithmic equivalent of this function); this rank ordering may only involve the max and min of the list on the positive value function, or short groupings of categories along this rank ordering of all categories;

(x) the rank ordering of the categories graphed on the K−H− value function, with their relative placement to other categories along the negative value function being determined by the shortest distance to the value function fit (i.e., to H⁻=a±b(K⁻±c)^{d} or the logarithmic equivalent of this function); this rank ordering may only involve the max and min of the list on the negative value function, or short groupings of categories along this rank ordering of all categories;

(xi) the rank ordering of the categories graphed on the K+σ+ saturation function, with their relative placement to other categories along the positive saturation function being determined by the shortest distance to the parabolic function fit of σ⁺=e(K⁺±f)²+g; this rank ordering may only involve the max and min of the list on the positive saturation function, or short groupings of categories along this rank ordering of all categories;

(xii) the rank ordering of the categories graphed on the K−σ− saturation function, with their relative placement to other categories along the negative saturation function being determined by the shortest distance to the parabolic function fit of σ⁻=e(K⁻±f)²+g; this rank ordering may only involve the max and min of the list on the negative saturation function, or short groupings of categories along this rank ordering of all categories;

(xiii) the rank ordering of the categories graphed on the H+H− trade-off function, with their relative placement to other categories along the trade-off function being determined by the shortest distance to the central tendency as described in (v), which can include a number of methods for mapping such a central tendency;

(xiv) the rank ordering of the categories graphed along the positive value function, just using K+ or H+ for rank ordering of categories; this rank ordering may only involve the max and min of the list on the positive value function, or short groupings of categories along this rank ordering of all categories;

(xv) the rank ordering of the categories graphed along the negative value function, just using K− or H− for rank ordering of categories; this rank ordering may only involve the max and min of the list on the negative value function, or short groupings of categories along this rank ordering of all categories;

(xvi) the rank ordering of the categories graphed along the positive saturation function, just using K+ or σ+ for rank ordering of categories; this rank ordering may only involve the max and min of the list on the positive saturation function, or short groupings of categories along this rank ordering of all categories;

(xvii) the rank ordering of the categories graphed along the negative saturation function, just using K− or σ− for rank ordering of categories; this rank ordering may only involve the max and min of the list on the negative saturation function, or short groupings of categories along this rank ordering of all categories. In an embodiment, the relative preference engine 2202 and the classification engine 2204 may replicate the clusters 2214 using other preference signature data, as indicated at block 2314 (FIG. 23B). For example, suppose the original data including ranking information from one million subjects. The relative preference engine 2202 and classification engine 2204 may construct classifications as described herein based on the data from 500,000 subjects. The relative preference engine 2202 and the classification engine 2204 may then attempt to replicate the clusters 2214 utilizing the data from the other 500,000 subjects. This replication process may work as a check of the construction of the clusters 2214. For example, if the clusters do not replicate exactly across the two sets, then the classification engine 2204 may determine new clusters using other combinations of the preference feature values. The replication process may be repeated until a consistent set of clusters are created across multiple attempts.

The classification engine 2204 assigns subjects to clusters 2214 as part of the construction of the clusters 2214. To the extent the relative preference engine 2202 and the classification engine 2204 did not utilize the data for all of the subjects, the classification engine 2204 may assign those subjects, as well as new subjects for whom sufficient movie ranking data exists, to the clusters, as indicated at block 2316. In particular, new subjects may be assigned to clusters 2214 based on the subject's preference feature values and the criteria established for the clusters 2214. If a given subject's preference feature values match the criteria established for a given cluster, e.g., 2214c, then the given subject may be assigned to that cluster 2214c. It should be understood that a given subject may be assigned to multiple clusters 2214. In addition, where the subject's preference feature values fail to meet the criteria defined for any of the clusters 2214, the subject may not be assigned to any cluster 2214.

The prediction engine 2208 may make one or more recommendations 2216 to a subject based on the one or more clusters 2214 to which the subject is assigned, as indicated at block 2318. For example, suppose a subject belongs to a particular cluster, e.g., 2214b, whose other members ranked a particular movie highly. Then, the prediction engine 2208 may recommend this particular movie to the subject. Because the subject belongs to the cluster 2214b, there is a high likelihood that the subject will also rank the particular movie highly. That is, the prediction engine 2208 bases its recommendation 2216 for a first subject based on information provided by other subjects assigned to the same cluster(s) 2214 as the first subject. The prediction engine 2208 also may base its recommendation 2216 on one or more of the preference feature values that define the cluster 2214 to which the first subject belongs. For example, if the cluster 2214 includes subjects that ranked Horror movies highly, and all or most of the other cluster members ranked a particular honor movie highly, the prediction engine 2208 may recommend this particular horror movie to the subject.

It should be understood that one or more steps may be omitted. For example, the replicate clusters step 2316 may be omitted. It should be understood that other methods may be employed.

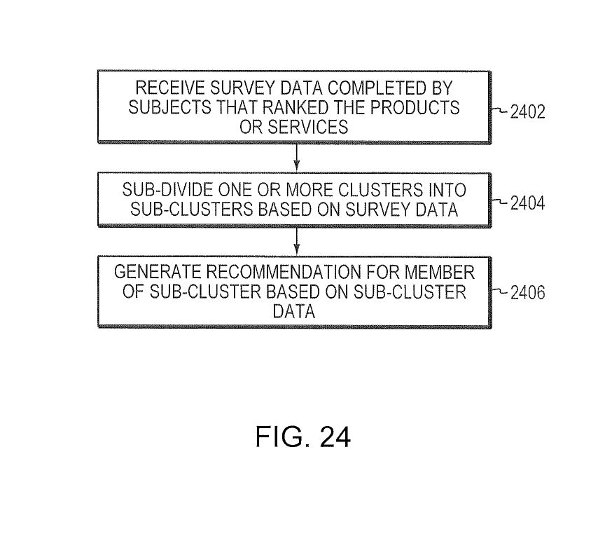

FIG. 24 is a flow diagram of another method in accordance with an embodiment of the invention. The subjects may be asked to complete a survey that collects demographic information on the subjects, such as age, sex, marital status, income level, education level, etc., and this information may be received by the classification engine 2204, as indicated at block 2402. The classification engine 2204 may utilize the survey results to divide a given cluster into a plurality of sub-clusters where the members of the sub-cluster share one or more demographic features, e.g., age, sex, age and sex, as determined by the survey, as indicated at block 2404. For example, a given cluster may be divided into a first sub-cluster that includes female subjects between the ages of 35-65, and a second sub-cluster that includes male subjects between the ages of 25-35. The prediction engine 2208 may then make a recommendation 2216 for a member of the first sub-cluster based on information from other members of that sub-cluster, as indicated at block 2406.

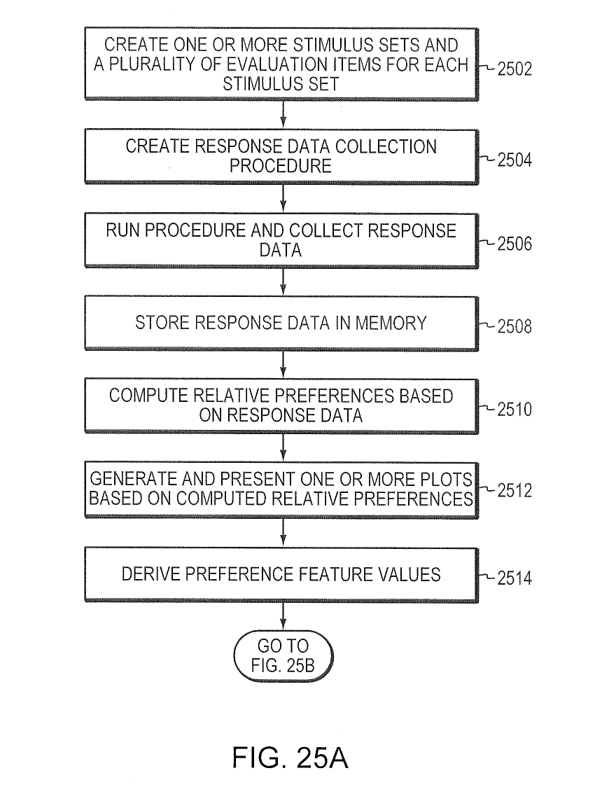

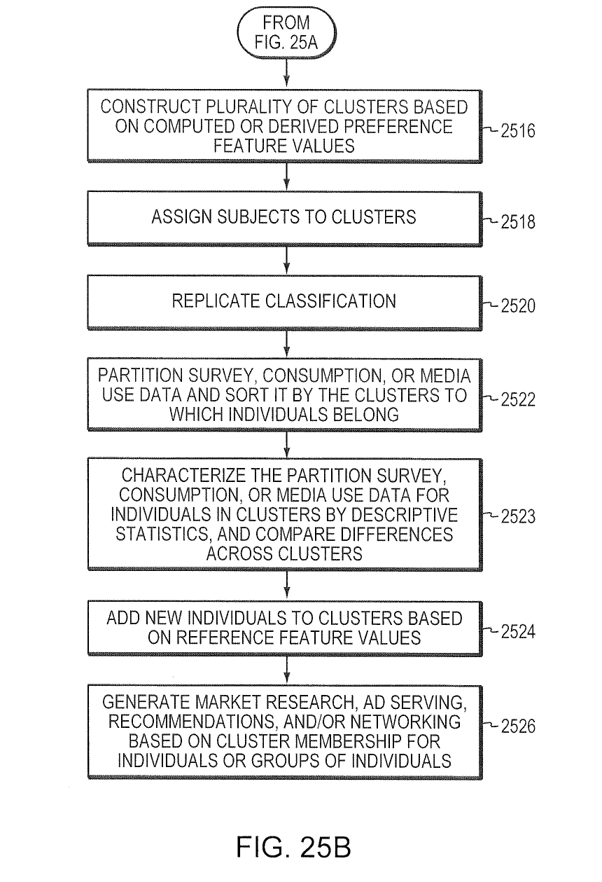

FIGS. 25A-B are a flow diagram of another method in accordance with an embodiment of the invention. In this embodiment, clusters are established using response data collected from participants who also are members of a large dataset of survey data, consumption or purchasing data, or product or service ranking data. Examples of large data sets of consumption data include data captured by retailers through the use of their reward card systems, data captured by credit card providers, or “big data” compilations by market research firms such as Big Insight, Inc. and Nielsen which are collected for large samples of subjects (e.g., 20,000 subjects or more) with potentially thousands of survey variables, etc.

A developer may create one or more stimulus sets where each stimulus set includes a plurality of evaluation items, as indicated at block 2502 (FIG. 25A). For example, a first stimulus set may represent travel, and the plurality of evaluation items may include images and/or videos of travel destinations and/or modes of travel, such as Europe, Mexico, Florida, California, Las Vegas, New York City, bus tours, cruise ships, etc. A stimulus set may represent fashion, and the plurality of items may include images and/or videos of various designer or off-the shelf clothing and accessories. A third stimulus set may represent dining, and the plurality of items may include images or video of types of food and/or restaurants, such as French food and/or restaurants, Mexican food and/or restaurants, Italian food and/or restaurants, etc. The one or more stimulus sets may be related to the survey, consumption, purchasing, or ranking data, or the one or more stimulus sets may be partially overlapping, or unrelated, e.g., completely different.

The developer next develops a response data collection procedure incorporating the evaluation items for the stimulus sets, as indicated at block 2504. In an embodiment, a suitable response data collection procedure is the keypress procedure described herein, which may be implemented through a computer program or application that displays the images or videos to each participant, and allows the participant to either extend or shorten the time that a given image or video is displayed by entering keypresses on a keyboard. It will be understood that other procedures may be used. For example, other suitable procedures include alternating keypresses, swiping across a touchscreen, tapping one or more fingers on a touchscreen, button holds on a keyboard or touchscreen, etc. In an embodiment, the procedure may be implemented at a website that a participant accesses using a browser application. The procedure may be designed to appear like a game that is played by the participant. An alternate embodiment might be on a cellphone, such as the iPhone, an e-reader device, an iPAD or similar portable computational or communication device.

A plurality of participants run the response data collection procedure, and the response data may be collected by the relative preference engine 2202, as indicated at block 2506. Response data generated during each participant's running of the procedure may be stored in memory, as indicated at block 2508. The relative preference engine 2202 processes the response data to generate relative preference data for the stimulus sets represented by the evaluation items, as indicated at block 2510. The relative preferences data may be plotted and the plots printed, displayed or otherwise presented to an evaluator, as indicated at block 2512. The relative preference engine 2202 may derive a plurality of preference feature values for each participant based on the preference data and plots, as indicated at block 2514. The classification engine 2204 may analyze the computed preference feature values, and construct a plurality of clusters 2214, as indicated at block 2516 (FIG. 25B). The classification engine 2204 may assign participants to the clusters, as indicated at block 2518. The classification engine may apply replication to revise and fine tune the classifications, as indicated at block 2520.

The large dataset of survey data, consumption or purchasing data, or product or service ranking data may be partitioned so it can be added to each cluster based on the survey data, consumption or purchasing data, or product or service ranking data of the is individuals included in each cluster as indicated in block 2522. Each cluster based on relative preference features may thus get a much larger set of variables regarding consumption, media usage and the like connected to it. This consumption or media use data may be characterized in descriptive statistical terms (e.g., as mean and standard deviation of a product used by the N number of subjects in the cluster), as indicated at block 2523.

New subjects, for whom recommendations or predictions are sought, may then run through the procedures in blocks 2506-2514 and not complete any survey questionnaires regarding consumption, media usage, or health issues, and be added to existing clusters, as indicated in block 2524. Predications regarding product opportunities/consumer demand, ad serving recommendations, consumption and purchase recommendations, and networking suggestions can be made as indicated in block 2526, based on cluster membership for individual subjects, or groups to which they self-identify, or cluster membership based on demographic and/or consumption data. That is, predictions of consumption may be made for individuals in a cluster for which that data is otherwise missing. The data associated with the cluster is used by the prediction engine 2208 to determine what the individual would prefer.

Additional Applications

It should be understood that the invention may be applied to many fields of endeavor. The following describes several exemplary applications of the present invention, but is not intended to be exhaustive. In general, applications of the invention include (a) marketing and advertising, (b) relative preference prediction to facilitate consumption based on recommendations made by product provider, (c) optimization of search engine functions by filtering of search results to an audience preference map, (d) product optimization and packaging for a target audience, (e) human resources, and (f) match-making, among others. For advising consumption, the invention may have direct implications for increasing consumption by making recommendations to consumers, such as book or movie recommendations. For optimization of search engine results, the invention may have implications for the optimal placement of advertisements for viewing by search engine users. For human resources as well as matching personnel to specific tasks, the invention may be applied by organizations in which a high school, college or graduate student enters the organization with a particular career path in mind, but may have an aptitude or preference for tasks or activities of the organization that are different. For match-making applications, the invention may be used to identify compatible individuals.

Movies or Literature

To evaluate movies, for example, participants or customers may be asked to complete a keypress task on the Internet. The response data may be processed as described herein to create a “preference vector” for the participant or customer in order to guide further recommendations for movies or books. The keypress procedure may be designed as an overt task, i.e., with no subliminal stimuli, and have five or more categories of stimuli conditions. One stimuli condition may be picture stills from 20 different horror movies. A second condition may be 20 picture stills from romantic movies, a third condition may be 20 picture stills from adventure and/or action movies, a fourth condition may 20 picture stills from comedies, a fifth condition may be 20 picture stills from mysteries, a sixth condition may be 20 picture stills from historical movies and/or documentaries, etc. In the context of literature, the experimental conditions may represent different genres of writing and the items in each experimental condition may include brief sections of text or auditory recordings or readings. These pictures or other stimuli could be presented over the Internet, e.g., from a web site, to the participant or customer, and the keypress response data collected regarding approach, avoidance, non-action about, or variable approach and avoidance of the evaluation items. The response data may be analyzed as described herein to assess the relative ordering of preferences across movie categories or literature genres on the trade-off plot(s), and assessed for which categories had the highest standard deviations, and thus represented “hard decisions” using the saturation plot, along with which relative orderings were consistent between approach vs. avoidance using the value function plot(s), and thus had the least inconsistency associated with decisions for or against them.

The relative preference data then may be compared to ratings a customer made over time for various categories of movies or books to identify the extent to which “local context effects” may influence the customer's ratings. Local context effects may include the proximity of one category of movie or book to another in their release or publication, or the critical reviews of particular movies or books, or the day of the week the movie or book was watched/read, or local events of salience. It is also salient that other factors besides movie or book category might be relevant to a customer's keypress responses, such as the Director of the movie, leading actor or actress, or author of the book.

Security

Behavioral tasks to assess unconscious hostility toward an organization such as a company, government or governmental entity, and sympathy toward violent extremism/fanaticism/intolerance may be implemented with the present invention in a number of ways. For example, a keypress procedure with ideologically biased pictures, e.g., pictures presenting actions supporting a government's interests or against a government's interests may be created or defined. This may be done either with subliminal pictures, e.g., pictures presented fast enough that the viewer does not gain conscious recognition of what is observed, or with overt pictures, e.g., consciously observed pictures.

In the subliminal task, two sets of subliminal stimulus conditions may be used. One security-based option or stimulus condition may include pictures showing events from a pro-terrorist and anti-government perspective. Another security-based option or stimulus condition may include pictures that showed events from an anti-terrorist and pro-government perspective. Both sets of subliminal stimuli may be presented before mildly positive or mildly aversive neutral pictures. The method by which the subliminal stimuli are made to be outside of the participant's conscious awareness may involve a number of techniques, such as the use of a “forward mask” and a “backward mask” that effectively sandwich the very brief subliminal stimulus and act as distracting stimuli. It should be understood that the use of masks reduces the chance that a participant may consciously perceive the subliminal stimulus. Nonetheless, a keypress procedure for security-based option may be created without masks and/or without subliminal stimuli.

For example, if ten pictures are used for each category of subliminal stimulus, then a participant could complete the test session in a relatively short time frame of approximately 20*8 seconds (assuming the default time of the exemplar keypress task explained for marketing)=160 seconds. The results of this keypress task then may be mapped into the relative preference space defined by (i) preference trade-off graphs, (ii) preference saturation graphs, and (iii) value functions of preference intensity against preference uncertainty. These graphs may be compared and contrasted for preference for or against violent action toward the subject government and its citizens. Findings of (a) active hostility toward the subject government, and (b) sympathy to extremist ideology could be integrated into an algorithm to assess violent intention (IA), and incorporate other potential risks for violent behavior, such as data from demographics, prior history, and known associates, to produce an index for response by governmental authorities.

This application may be employed at one or more points of entry into the territory of the subject government, at its Embassies and/or consulates overseas, at airports, ports and other legal border crossing points, and at immigration detention sites.

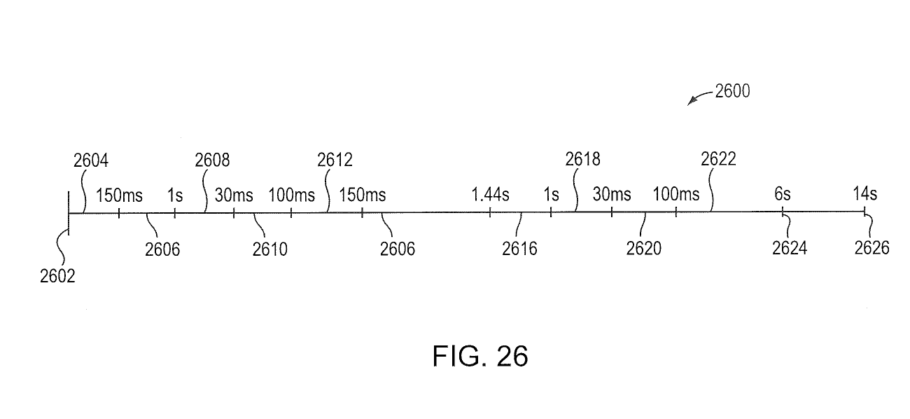

FIG. 26 is a timeline 2600 of an embodiment of a keypress procedure for use in a security-based application of the present invention. The keypress procedure for a security-based application may include a series of tasks in which both a subliminal stimulus and a corresponding overt evaluation item are presented to the participant during the course of each keypress task. The subliminal stimulus is presented to the participant for so short a time that the participant is not consciously aware of the subliminal stimulus. The overt evaluation item is presented to the participant for a long enough period of time for the participant to be consciously aware of it. However, as described herein, the keypress procedure is designed so that the participant's behavior regarding the subliminal stimulus is reflected in his or her keypress activity for the overt evaluation item. That is, the keypress activity entered during the presentation of the overt evaluation item is a function of the participant's approach or avoidance regarding the subliminal stimulus.

In an embodiment, the security-based keypress procedure includes three experimental conditions: (i) positive and pro-government images; (ii) neutral objects or scenes; and (iii) negative and anti-government images. Items (i) and (iii), which are the subliminal stimuli, may have extreme intensity ratings with a positive valence for (i) and a negative valence for (iii) when rated by participants who strongly favor the government, e.g., are patriotic. For the positive and pro-government subliminal stimuli, the corresponding overt evaluation items may have mild positive intensity ratings and the corresponding overt evaluation items may have mild negative intensity ratings. Suitable images for use as the overt evaluation items may be bland pictures of objects or rooms.

The portion of the keypress procedure associated with each subliminal stimulus, e.g., each pro-government or anti-government photograph or video clip, has a start time 2602. In a first fixation period 2604, a blank screen with a central fixation point in the form of a cross, asterisk, or other character, is presented to the participant in the viewing area 402 (FIG. 4) as a transition between the prior subliminal stimulus and the current subliminal stimulus. The first fixation period 2604 may last approximately 150 milliseconds (ms). The first fixation period 2604 may be followed by a first forward mask period 2606 during which a forward mask image is presented to the participant in the viewing area 402 of the screen 400. The first forward mask period may last approximately 1.0 seconds (s). In an embodiment, a forward mask image is a mosaic of image snippets from some or all of the overt plus covert evaluation items corresponding to the current security-based option. The image snippets may be arranged in a checkerboard fashion with each snippet located in a square of the checkerboard to create the mosaic. Each image snippet may be small enough and the snippets scrambled so that the forward mask image does not have any recognizable images or patterns to the participant.

The first forward mask period 2606 may be followed by a first subliminal or covert stimulus period 2608 during which the subliminal stimulus is presented to the participant on viewing area 402. The first subliminal stimulus period 2608 may last for 30 ms. Following the first subliminal stimulus period 2608 may be a first backward mask period 2610 during which a backward mask image is presented to the participant on the viewing area 402. The first backward mask period 2610 may last for approximately 100 ms. In an embodiment, a backward mask image is also a mosaic of image snippets from some or all of the overt plus covert evaluation items corresponding to the current security-based option. As with the forward mask image, the image snippets for the backward mask image may be arranged in a checkerboard fashion with each snippet located in a square of the checkerboard to create the mosaic. Each image snippet may be small enough and the snippets scrambled so that the backward mask image does not have any recognizable images or patterns to the participant. In an embodiment, the backward mask image is different from the forward mask image.

Following the first backward mask period 2610 may be a first overt evaluation period 2612 during which the overt evaluation item that has been associated with the current subliminal stimulus is presented to the participant in the viewing area 402. The first overt evaluation period 2612 may last for 150 ms. Following the first overt evaluation item period 2612 may be a second fixation period 2614 in which the viewing area 402 is again blank with a central fixation point in the form of a cross or asterisk. The second fixation period 2614 may last approximately 1.44 seconds. Following the second fixation period 2614 may be a second forward mask period 2616 in which the same forward mask image or a new forward mask image is presented to the participant in the viewing area 402. The second forward mask period 2616 also may last approximately 1.0 second. The second forward mask period 2616 may be followed by a second subliminal stimulus period 2618 during which the subliminal stimulus is again presented to the participant in viewing area 402. The second subliminal stimulus period 2618 also may last for 30 ms. Following the second subliminal stimulus period 2618 may be a second backward mask period 2620 during with the same backward mask image or a new backward mask image is presented to the participant in the viewing area 402. The second backward mask period 2620 also may last for approximately 100 ms. Following the second backward mask period 2620 may be a second overt evaluation item period 2622. The second overt evaluation item period 2622 may last for a default time 2624, e.g., approximately six seconds, if the participant takes no action.

As described above, the participant can act to either lengthen or shorten the time that the second overt evaluation item remains displayed in the viewing area 402. As mentioned above, if the participant takes no action, the overt evaluation item is removed or stopped at the default time 2624, which again may be six seconds, and the keypress procedure proceeds to the next subliminal stimulus/over evaluation item pair. If the participant finds the overt evaluation item to be desirable or appealing, which behavior will be a function of the subliminal stimulus, the participant may lengthen the time by which it remains displayed past the default time 2624 by alternatingly pressing the approach keys. By continuing to toggle between the approach keys, the participant can cause the overt evaluation item to continue to be displayed up to a maximum time 2626, e.g., fourteen seconds, thereby signaling both a preference toward the current evaluation item, i.e., the subliminal stimulus, and the intensity of the participant's preference toward the current evaluation item, i.e., the subliminal stimulus.

If the participant dislikes the overt evaluation item, the participant may shorten the time by which it is displayed by alternatingly pressing the avoidance keys. By continuing to toggle between the two avoidance keys, the participant can stop the display of the current evaluation item sooner than the default time 2624, thereby signaling both a dislike of the current evaluation item, i.e., the subliminal stimulus, and the intensity of the participant's dislike toward the current evaluation item, i.e., the subliminal stimulus.

It should be understood that variations to the security-based keypress procedure may be made, such as changing one or more time periods, re-arranging the order, adding new experimental steps in a keypress task, and/or removing steps in the experimental task.

Internet Search Engine/Preference Vector

Behavioral tasks to assess preferences toward categories of material, such as materials used in web-based searches with a search-engine, may be readily implemented with the present invention. This information may also be used to better target advertisements to search-engine users.

Specifically, an organization could ask a customer to complete a keypress task on the web, whose data is then used as a “preference vector” to filter the output of web searches. For example, individual may complete a keypress procedure or task with 20 distinct experimental conditions. These experimental conditions may include the following: (1) technology, (2) religion, (3) psychology/behavior/self-help, (4) cooking/home-economics, (5) weaving/sewing/fashion, (6) animals/pets, (7) sports, (8) history/war, (9) literature, (10) art/sculpture, (11) science/math, (12) fishing/hunting/outdoors/guns, (13) cars/boating, (14) home improvement/architecture, (15) gardening/plants, (16) music, (17) economics/business, (18) politics/government, (19) law enforcement/legal history, (20) movies/entertainment/pornography. From this keypress task, the individual's trade-off graph, value function, and saturation function are produced, and they may show, for example, a clear high preference for music, above home-improvement or gardening, and above law-enforcement. This same person then may submit an Internet search using a search engine with the word “pick”. The word “pick” could also have been a phrase, or set of words. In the case of the word “pick” it has meanings related to “guitar pick”, “pick-ax”, “pick a lock”, “choose an item”, or “mistreat someone”. By utilizing the individual's preference vector, the search engine may determine that there is a higher probability that the reference from this particular individual was likely to be to a “guitar pick”, than “pick-ax” (for home improvement or for gardening) or “pick a lock” and “mistreat someone” (for law enforcement/legal issues).

In addition, the above-described preference mapping may be used by the Internet search engine to focus the type of advertisements that are displayed to the individual along with the search results. The above-described preference mapping may also be used to select one or more additional keypress procedures or tasks to generate more fine-tuned and specific topics and issues of interest to the individual.

Production Optimization and Packaging

Behavioral tasks to assess preferences toward variants of products, or new products, may also be performed with the present invention. For example, a “keypress” procedure may be defined in which an individual browses music. Here, the individual may scroll through the music, rather than keypress. For example, the individual may have a set amount of time in which to listen to a song. The individual may end his or her listening to a current snippet of a song with one command, or extend his or her listening with another command once they have come to the end of the current music snippet. The individual also may be able to extend his or her listening over the entire song. The collected response data relates to the total time that the individual listened to the song given. Based on this response data, positive value function and saturation plots across a number of different categories of music, or across distinct bands/performers may be generated. In addition a mean time may be used alternately to put together a trade-off graph, a positive and negative value function and a saturation function. From this relative preference mapping, the system and/or an evaluator may determine the types of music the individual prefers, and thus make better recommendations.

Similarly, a set of variants of new music that a band is producing may be placed on a website. Based on the response data generated by many people and the organization of those people based on demographic information, relative preference data may be used to package specific sets of song versions for a new album, and to target the specific compilations of song variants to specific consumer groups.

This same approach also may be used for competitions between bands, or to determine where musical tastes are moving in particular parts of a country or specific target consumers.

A similar application may be implemented to select packaging for a product that is different than music, such as T-shirts, fashion items, etc.

Human Resources

The system and method of the present invention may be used to assess issues relating to the needs of a specific organization, such as a business. For example, a shipping business may need individuals for monitoring sonar, planning the course for a freight boat, determining what crew are needed, matching the freight needed at a site to what is available for shipping at the port of origin, etc. Based on a keypress procedure or task that assesses experimental conditions targeting these topics, job applicants may be more optimally placed with the job for which they have the highest interest.

Alternately, a keypress procedure or task may be created or defined to assess how a job applicant responds to issues of relevance for a service company, or how best a service company might allocate its existing work force. For example, cleanliness and how employees respond to having an organized and well-maintained work environment may be important to a particular organization or business, such as a food service company. A keypress procedure or task may be used to assess how relevant cleanliness is to a prospective employee or an existing member of the organization's staff.

Alternately, a detailed keypress procedure or task relating to interests in engineering may be used in order to best select a team for a particular contract within a technology firm.

Alternately, a keypress procedure task may be defined or created that involves experimental conditions for many of the types of tasks a military organization, such as an army, needs in the field of deployment, so as to fit recruits to a needed work function.

Match-Making

For match-making, finding a match between two people may be improved by looking for matches between two preference mappings as described above in connection with the Internet Search Engine/Preference Vector. Mapping an individual's preference space to create a trade-off plot, value function, and saturation function over some set of experimental conditions may be referred to as a “preference map”. The relative ordering of preferences and their intensity (as from a value function) may be referred to as a “preference vector”. For match-making, the preference vectors of various individuals may be compared to find optimal matches by considering components of the preference maps of different people, in a step-wise manner. For example, a keypress procedure or task may start with high-level, e.g., global experimental conditions, and then use ever more selective sets of mappings that go into greater detail about the likes, wants, social, cultural, and intimacy issues of participants to fine-tune matches between people.

The foregoing description has been directed to specific embodiments of the present invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed is:

1. A method of generating a recommendation, the method comprising:
receiving a data set that contains a plurality of product or service rankings made by a plurality of individuals, the products or services having at least one criteria;
translating at least some of the rankings to approach response data, where the approach response data indicates a degree of an individual's approach toward a respective product or service;
organizing the plurality of products or services into a plurality of categories based on the at least one criteria;
computing, for each individual, by a processor, an approach entropy value for at least some of the categories, where the approach entropy value for a respective category is computed as a function of the individual's approach response data for the products or services organized into the respective category;
determining for each individual a relative preference order of the categories of products or services, the relative preference order based on the individual's computed approach entropy values;
organizing the individuals into trade-off clusters where the individuals within each trade-off cluster share the same relative preference order of at least some of the categories of products or services; and
making a recommendation of a given product or service to an individual organized into a first trade-off cluster, the given product or service being recommended having received a high ranking by other individuals organized into the first trade-off cluster.

2. The method of claim 1 further comprising:
computing, for each individual, mean approach intensity values for at least some of the categories, where the mean approach intensity value for a respective category is computed as a function of the individual's approach response data for the products or services organized into the respective category;
translating at least some the rankings to avoid response data, where the avoid response data indicates a degree of an individual's avoidance of a respective product or service;
computing, for each individual, mean avoid intensity values for at least some of the categories, where the mean avoid intensity value for a respective category is computed as a function of the individual's avoid response data for the products or services organized in the respective category;
computing, for each individual, by the processor, an avoid entropy value for at least some of the categories, where the avoid entropy value for a respective category is computed as a function of the individual's avoid response data for the products or services organized into the respective category;
generating a value function plot, where the value function plot plots approach entropy values versus mean approach intensity values for respective categories, and avoid entropy values versus mean avoid intensity values for respective categories, the value function plot defining one or more preference orders of the categories;
instead of organizing the individuals into the trade-off clusters, organizing the individuals into value function clusters where the individuals within each value function cluster share the same one or more preference orders of the categories from the value function plots;
instead of making the recommendation based on membership in the trade-off clusters, making a recommendation of a particular product or service to an individual organized into a first value function cluster, the particular product or service being recommended having received a high ranking by other individuals organized into the first value function cluster.

3. The method of claim 2 where the products or services are selected from the group consisting of:
movies,
television shows,
books,
songs,
albums,
consumer products, and
appliances.

4. The method of claim 3 wherein
the product or service rankings are either number rankings or star rankings; and
the number or star rankings are translated into keypress data.

5. The method of claim 1 further comprising:
normalizing the computed approach entropy values for at least some of the individual to account for different numbers of products or services being ranked by the at least some of the individuals in the plurality of categories.

6. The method of claim 1 further comprising:
validating the trade-off clusters, the validating including:
receiving a second data set that contains rankings of the plurality of products or services made by a second plurality of individuals,
translating the rankings of the second data set to approach response data,
computing, for each of the second plurality of individuals, by the processor, approach entropy values for at least some of the categories,
determining for each of the second plurality of individuals a relative preference order of the categories of products or services, the relative preference order based on the second plurality of individuals' computed approach entropy values;
organizing the second plurality of individuals into a second set of trade-off clusters where the second plurality of individuals within each of the second set of trade-off clusters share the same relative preference order of at least some of the categories of products or services; and
determining that the trade-off clusters organized using the data set are the same as the second set of trade-off clusters.
